(19) United States
(12) Patent Application Publication
(10) Pub. No.: US 2026/0111009 A1
(43) Pub. Date: Apr. 23, 2026

(54) METHOD FOR CHANGING A PROCESSING JOB CARRIED OUT ON A PROCESSING MACHINE

(71) Applicant: KOENIG & BAUER AG, Würzburg (DE)

(72) Inventors: Bastian DEPPISCH, Karlstadt (DE); Torsten MÜLLER, Güntersleben (DE)

(21) Appl. No.: 19/121,887

(22) PCT Filed: Apr. 4, 2024
(86) PCT No.: PCT/EP2024/059147

§ 371 Date: Apr. 17, 2025

(30) Foreign Application Priority Data
Apr. 27, 2023 (DE) 10 2023 110 902.2

(51) Int. Cl. G05B 19/418

(52) U.S. Cl. CPC G05B 19/41865; G05B 2219/34379; G05B 2219/40066

(57) ABSTRACT

Examples relate to changing a processing job carried out on a processing machine including a processing unit configured as an application unit, and a processing unit configured as a shaping unit. A first processing job is completed by the processing machine, during which a substrate is processed by the processing units. The first processing job is automatically terminated and a modification is automatically started for adapting at least one unit of the processing machine to a configuration of a directly succeeding processing job. Prior to the modification, the configuration for the directly succeeding processing job is provided to a machine control system. During the modification, at least one modification process of the shaping unit is performed to temporally overlap with at least one further modification process of the processing machine. The directly succeeding processing job is started, during which at least one substrate is processed by the processing units.

### CROSS-REFERENCES TO RELATED APPLICATIONS

This application is the U.S. national phase, under 35 USC § 371, of PCT/EP2024/059147, filed on Apr. 4, 2024, published as WO 2024/223254 A2 on Oct. 31, 2024, and claiming priority to DE 10 2023 110 902.2 filed on Apr. 27, 2023, and all of which are expressly incorporated by reference herein in their entireties.

### TECHNICAL FIELD

Examples herein relate to a method for changing a processing job carried out on a processing machine that includes a plurality of processing units, including at least one processing unit configured as an application unit including a plate cylinder, and at least one processing unit configured as at least one shaping unit, the at least one shaping unit being configured as at least one rotary die-cutting device.

### BACKGROUND

Various processing units are used in processing machines, in particular for sheets such as corrugated cardboard sheets. Printing fluid is applied to the sheets by means of at least one application unit and, additionally or alternatively, the mass and/or shape and/or contour of the sheets are altered by way of at least one shaping device. Flexographic printing is one possible application method. Flexographic printing is characterized by a plate cylinder including a flexible printing plate. A die cutter, in particular a rotary die cutter, is usually a possible shaping device. The rotary die cutter usually comprises a plate cylinder, which is also referred to as die-cutting cylinder hereafter, comprising a tool and an anvil cylinder.

Rotary die cutters usually comprise die-cutting units which include a die-cutting cylinder and an anvil cylinder. For example, DE 10 2004 058 597 A1 shows a die cutter comprising two rotating processing rollers.

Such a processing machine, comprising application units and a shaping unit designed as a rotary die-cutting device, is likewise disclosed by WO 2020/216521 A1.

So as to carry out a new processing job on the processing machine, the processing machine usually has to be modified and/or serviced subsequent to a processing job having taken place before that. Usually, a process to be modified is launched manually by the operator.

A cutting die including die-cutting tools, preferably blades, is arranged on a die-cutting cylinder, which process the substrate during operation, while also making contact with the anvil cylinder. The anvil cylinders preferably include elastic and resilient covers or die cutting blankets. During a job change, by which the die-cut pattern to be generated is altered, the cutting dies must be replaced. So as to return the rotary die cutter into an operational state quickly, for example, changing devices for die-cutting cylinders are used.

US 2005/0103173 A1 shows an option for exchanging die-cutting cylinders, with these being displaced by means of linear guides.

Different approaches for automating processes for changing processing jobs are known from various technical fields of the graphics industry.

For example, EP 2 636 536 A1 discloses, for the technical field of production plants, a method for modifying the production plant, which comprises a plant control unit and is made up of several machines that each comprise a machine control system and are used for post print processing. One post print processing machine of the post print processing machines is modified fully automatically or semi-automatically for a subsequent production job. The plant control unit coordinates the activation of the individual machines in the combination, wherein the machine control systems are responsible for the functions of the relevant machine.

DE 10 2004 021 657 A1 discloses a method for carrying out a printing plate-specific production change on a printing machine, wherein a first print job is automatically stopped and parameters for a subsequent print job are automatically loaded. After production readiness for the second print job has been achieved, a production readiness signal for the second print job is generated automatically, wherein the second print job is not started until the print job has been confirmed, and a time between the generation of the production readiness signal and the print job confirmation is monitored and detected.

US 2014/0003853 A1 discloses a method for reducing scrap on a digital web-fed printing machine. During a first print job, the substrate web is moved at a first speed and printed by at least one print head and processed by a downstream post-processing device. The post-processing device comprises wheels for slitting to create longitudinal slits and a cutting device for cutting the web into sections. The substrate web is decelerated before the first print job ends. The configuration of the post-processing device is changed for a second print job. Another section of the substrate web is printed in accordance with the second print job before the change in configuration of the post-processing device is completed, wherein the duration until the change in configuration is completed and the further section of the substrate web reaches the post-processing device is taken into consideration.

DE 10 2018 202 747 A1 discloses a method for carrying out a job change on a machine from the graphics industry, for example a sheet offset rotary printing machine, with a job change menu provided by a processor. An operator is provided with preselection options for automatically switching from production printing to a job change program or for automatically switching from a job change program to production printing.

JP 4089891 B2 relates to an input circuit for a tension detector of a tension controller, which is mounted in tension control devices. The tension detector is used, for example, as a device for controlling a tension of a thin strip such as paper, film, wire or the like. A baseline calibration is carried out on a halted machine.

US 5,447,102 A discloses an operation of a printing machine, with various printing jobs being performed consecutively. During modification processes, settings can be implemented for the subsequent printing job.

The teaching of WO 2022/074071 A1 or US 2023/0373124 A1 discloses a processing machine and a method for calibrating a processing machine. The processing machine comprises multiple units, in particular flexographic printing units, a feeder unit, and a unit designed as a rotary die-cutting module. Transport units comprising rollers for transporting the sheets are provided between the sheet-processing units. A calibration system captures an indicium on the individual transported sheets and calculates a deviation of a longitudinal coordinate and of a lateral coordinate from a reference. A correction program is initiated when at least one of the longitudinal indicia displacements and of the lateral indicia displacements exceeds a predetermined tolerance threshold. A general option is disclosed for utilizing the machine for processing a series of batches with different types of boxes in terms of formats and print images, wherein the rotary die-cutting tool needs to be changed if the box dimensions and configuration change. Upon receipt of a job specification, the operator configures the processing machine by changing the rotary die-cutting tool of the die-cutting cylinder and then adjusting the lateral position of the sheets in the feeder module and setting the longitudinal register. A register correction can be performed on the rotary die-cutting module when feeding is suspended and the machine is empty.

### SUMMARY

It is an object of some examples herein to provide a method for changing a processing job carried out on a processing machine.

The object is achieved according to some examples herein by the method performed on the processing machine discussed above. The method may include completing a first processing job by the processing machine, during which at least one substrate is processed by the at least two processing units of the processing machine; automatically terminating the first processing job and automatically starting a modification; completing the modification of the processing machine for adapting at least one unit of the processing machine to a configuration of a directly succeeding processing job, prior to the modification, the configuration of the processing machine for the at least one succeeding processing job being loaded into and/or set and/or stored in a machine control system, and, during the modification, at least one modification process of the at least one shaping unit running so as to temporally overlap with at least one further modification process of the processing machine; and the machine control system controlling the at least two modification processes that run so as to temporally overlap; and starting the directly succeeding processing job, during which at least one substrate is processed by the at least two processing units.

The processing machine comprises several units. The processing machine comprises at least two processing units. At least one processing unit of the processing machine is designed as a shaping unit. The processing machine comprises at least one processing unit, preferably at least two, more preferably at least four, for example six, processing units designed as application units. The at least one application unit comprises at least one plate cylinder. In addition to the at least one application unit, the processing machine comprises the at least one processing unit designed as a shaping unit, preferably as a die-cutting unit, which is designed as a rotary die-cutting device. The at least one processing unit designed as a shaping unit is designed as a rotary die-cutting device. The at least one application unit is, preferably all application units are, preferably arranged upstream from the at least one shaping unit, in the transport direction of substrate. At least two processing units of the processing machine thus carry out different processing operations.

Units of the processing machine are modified for changing the processing job. In particular, the processing units of the processing machine are modified and/or serviced for changing the processing operation. The processing machine is preferably designed as a sheet processing machine for processing sheet-format substrate. In particular, the processing units are designed to process sheet-format substrate.

A method for changing a processing job carried out on the processing machine comprises multiple steps.

At least one first processing job is completed by the processing machine. During this first processing job, at least one substrate is processed by way of the at least one processing unit, in particular the at least one shaping unit and/or the at least one application unit, more preferably the at least one shaping unit and the at least one application unit, of the processing machine. In this way, the at least one substrate is processed by the at least two processing units of the processing machine during the first processing job. Preferably, a first product is generated according to the first job. This product preferably includes at least one print image and/or at least one die-cut pattern.

The first processing job is ended automatically. A modification starts automatically. This advantageously creates an uninterrupted transition from the first processing operation to the modification. Advantageously, delays due to necessary inputs by an operator are avoided.

This is followed by a completion of the modification of the processing machine for adapting at least one unit of the processing machine to a configuration of a directly succeeding processing job. Prior to the modification, the configuration of the processing machine for the at least one succeeding processing job is loaded into and/or set in and/or stored in a machine control system. Advantageously, all the necessary information for adapting the processing machine is available in the machine control system at the beginning of the modification and prepared for carrying out the required processes. In this way, advantageously an uninterrupted transition takes place between the first processing job and the modification.

The first processing job is followed by at least one, for example at least two, succeeding processing jobs. After the modification has been completed, the directly succeeding processing job is started. During this directly succeeding processing job, at least one substrate is processed by way of the at least one shaping unit. In addition or as an alternative, the at least one substrate is processed by way of the at least one processing unit designed as an application unit. The at least one substrate is thus processed by way of the at least two processing units of the processing machine during the directly succeeding processing job. Preferably, a second product is generated according to the second job. This product preferably includes at least one print image and/or at least one die-cut pattern.

The achievable advantages are, in particular, that a modification between processing jobs is simplified. The configuration of the processing machine and the modification for a succeeding processing job are advantageously carried out in a time-optimized manner. In particular, the configuration for the at least one succeeding processing job, in particular the change processes and/or cleaning processes and/or format adaptations required therefor, is or are completed prior to the necessary modification, whereby the modification can advantageously start without interruption after the preceding processing job has ended. Advantageously, the preparation of a subsequent production run and/or the execution of modification processes required for a job change are carried out automatically. This advantageously allows multiple modification processes to run so as to temporally overlap, preferably parallel to one another. Advantageously, the modification is expedited. Idle times of the processing machine are advantageously reduced, whereby the productivity of the processing machine is increased. Manual interventions of an operator during the modification are advantageously reduced. The operator is thus advantageously already available for other tasks.

The modification is preferably carried out according to a first type of modification or according to a second type of modification. The first type of modification preferably allows a multiplicity of modification processes and/or a change of the substrate to be processed to a different format or a different type. The second type of modification preferably enables a particularly rapid modification, and thus a minimized modification duration.

Preferably, at least two modification processes, preferably all modification processes, during the modification take place automatically and/or depending on one another, controlled by the machine control system. This advantageously optimizes the flow of the modification processes, and in particular reduces the duration of the overall modification.

In a preferred embodiment, data regarding a substrate to be processed and/or data regarding a product to be achieved from the at least one succeeding processing job are stored or have been stored in the machine control system. Preferably, by processing these data taking further machine-related data provided by the machine control system into consideration, the machine control system specifies the configuration of the processing machine for the at least one succeeding processing job as well as the modification processes to be carried out in this regard. This advantageously minimizes input errors of an operator. In particular in the case of recurring processing jobs, the effort for the data to be input by an operator can thus preferably be minimized.

In a preferred embodiment, the machine control system proposes at least one data set encompassing at least one configuration of the succeeding processing job as well as the modification processes to be carried out in this regard, which can be adapted or selected by an operator. An operator can thus advantageously adapt the configuration.

For example, the operator can integrate an additional modification process, such as a cleaning process, or remove a modification process, for example, deselect a cleaning process, when an application fluid remains the same, or can deselect a wear-related replacement of a tool when the remaining service life thereof is sufficient for the succeeding processing job. Advantageously, each unit of the processing machine is configured by the machine control system. More preferably, the configuration of each unit of the processing machine can be adapted or selected by an operator.

In a preferred embodiment, the configuration of the at least one directly succeeding processing operation and the configuration of at least one further succeeding processing operation as well as the at least one modification process to be carried out are loaded and/or set and/or stored at least prior to the particular modification, for example, while the first processing job is being completed. In this way, chains of multiple processing jobs can advantageously be carried out in a time-optimized manner. Advantageously, this offers relief to an operator.

The machine control system controls at least two modification processes that are running. More preferably, these at least two modification processes run automatically, that is, preferably without additional action by the operator. Advantageously, this offers relief to an operator.

At least two modification processes run so as to temporally overlap, preferably parallel to one another. This advantageously reduces the duration of the modification. These processes are controlled by the machine control system. More preferably, at least the modification processes that run so as to temporally overlap with one another run automatically during the modification. At least the modification processes that run so as to temporally overlap with one another during the modification, preferably at least three modification processes during the modification, more preferably the modification processes of at least the processing units, preferably run automatically. The automation advantageously offers relief to an operator.

During the modification, at least one modification process of the at least one shaping unit runs so as to temporally overlap with, preferably parallel to, at least one further modification process of the processing machine. In particular, at least one modification process takes place in each of at least two different units of the processing machine, preferably in at least two of the processing units, more preferably in all processing units, so as to temporally overlap with, preferably parallel to, one another. For example, a modification process of the shaping unit constitutes a time-limiting factor of the modification. Advantageously, the flow of the modification processes is optimized, and in particular the duration of the overall modification is reduced.

The units that the processing machine preferably comprises are at least the at least one shaping unit, the at least one application unit, the at least one substrate feed device, and the at least one delivery unit, wherein more preferably at least three modification processes of these components of the processing machine run so as to temporally overlap with one another during the modification, preferably automatically. This advantageously optimizes the flow of the modification processes, and in particular reduces the duration of the overall modification.

In an additional or alternative particularly preferred embodiment, the machine control system controls an automated termination of the first processing job, an automated start of the modification as well as an automated execution of at least the temporally overlapping modification processes of the modification. Advantageously, the effort involved for an operator during the modification is reduced. Advantageously, the modification is optimized in terms of the flow.

The at least one shaping unit is modified by at least one modification process. For example, at least one tool and/or at least one plate cylinder are changed. For example, only the tool is changed; alternatively, for example, the plate cylinder including the tool arranged thereon is changed. The plate cylinder is changed, for example, by means of a device for changing the plate cylinder, preferably automatically, or manually by an operator. The plate cylinder and/or the anvil cylinder are preferably removed from the processing point, preferably backed-away, prior to a change. The tool of the plate cylinder is preferably changed manually. In particular, during a manual change, the plate cylinder is preferably automatically made accessible to the operator. For example, subsequent to having changed a plate cylinder, a distance between the installed plate cylinder or the plate cylinder provided with the changed tool and the anvil cylinder is adapted. For example, the distance is also altered for the adaptation to a format of the substrate.

The at least one application unit, which is preferably designed as a flexographic application unit, is preferably modified by at least one modification process. Preferably, at least one modification process of the at least one application unit runs automatically so as to temporally overlap with the at least one modification process of the at least one shaping unit. This advantageously reduces the duration of the modification. Preferably, at least one modification process of the following modification processes is carried out on the at least one application unit: cleaning an application mechanism and/or altering a distance between a plate cylinder and an impression cylinder of the at least one application unit and/or changing a utilized application fluid and/or adapting an application volume of a utilized application fluid and/or changing a plate cylinder of the at least one application unit and/or changing at least one printing plate of the at least one application unit and/or changing an anilox roller of the at least one application unit. Advantageously, a print image to be achieved is adapted to the processing job to be carried out.

For example, during the modification, in addition or as an alternative to further modification processes, the number of processing units processing a substrate, in particular the number of application units, is altered. This advantageously increases the flexibility of the processing machine, and thus the usage options thereof.

Preferably, the at least one substrate feed unit is modified by at least one modification process. Preferably, the at least one delivery unit is modified by at least one modification process. In a preferred embodiment, an adaptation to a format of a substrate to be processed is carried out during at least one modification process of the substrate feed unit and/or of the delivery unit. For example, at least one of the modification processes for the adaptation to the format takes place automatically.

Advantageously, when converting a format of the substrates to be processed, at least one modification process for the adaptation to the new format takes place, in particular on the substrate feed unit and/or the delivery unit, but preferably additionally also on at least one processing unit, for example, by changing the distance between the cylinders at a processing point or by exchanging the plate cylinders, the tool and/or printing plates.

During the modification according to the second type of modification, substrate is preferably blocked from being fed to the at least one processing unit for only 0 to N substrates, with N being a natural number smaller than or equal to 25. More preferably, the feeding for at least one substrate is blocked. Additionally, at least one transport device of a transport unit of the processing machine for transporting substrate is driven with at least one speed profile during the modification, the speed being greater than zero. During the modification, preferably at least one plate cylinder of the at least one shaping unit is driven at a speed greater than zero.

Preferably in addition or as an alternative, the at least one application unit comprises at least one pushing-out device, which can adjust and/or is designed to adjust the position of a fluid source, if the same is present. Advantageously, the pushing-out device automates at least one operation of the application unit, and at least one modification process, in particular a cleaning process, is expedited. Interventions by an operator are minimized, preferably become obsolete.

### BRIEF DESCRIPTION OF THE DRAWINGS

Further advantages are apparent from the following description of the drawings. Exemplary embodiments of the invention are illustrated in the drawings and will be described in greater detail below. The figures show:

FIG. 1 a schematic illustration of a processing machine comprising application units and a shaping unit;

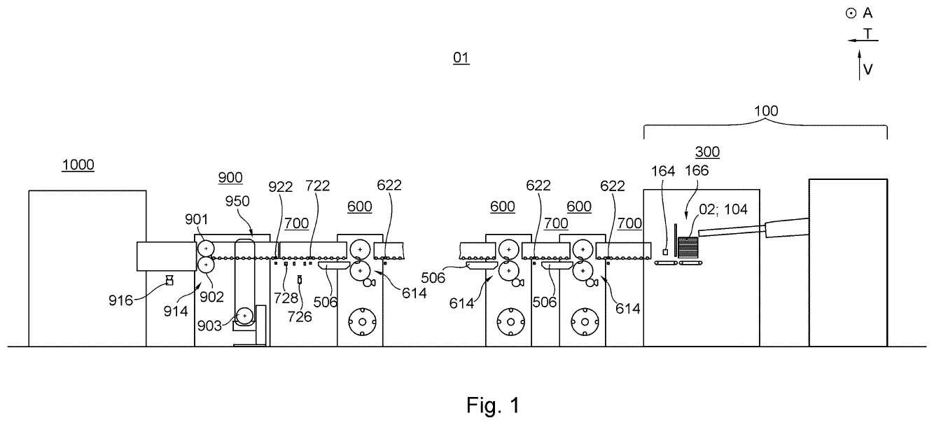

FIG. 2 a side view of a processing machine in a preferred configuration, comprising four printing mechanisms and the die-cutting unit including a device for changing;

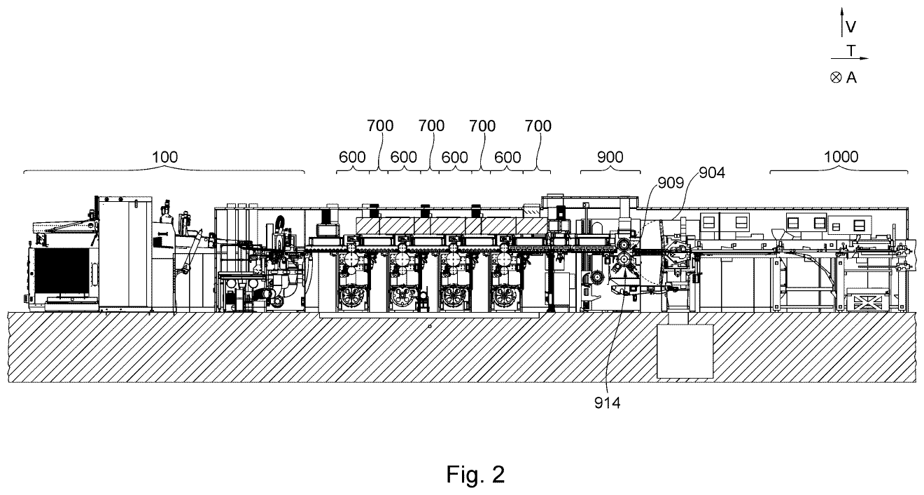

FIG. 3a a schematic illustration of an application unit with ink application from beneath;

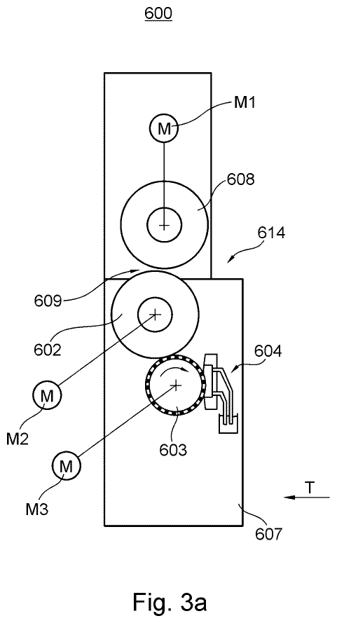

FIG. 3b a schematic illustration of an application unit with ink application from beneath and a schematically illustrated pushing-on device of an ink source;

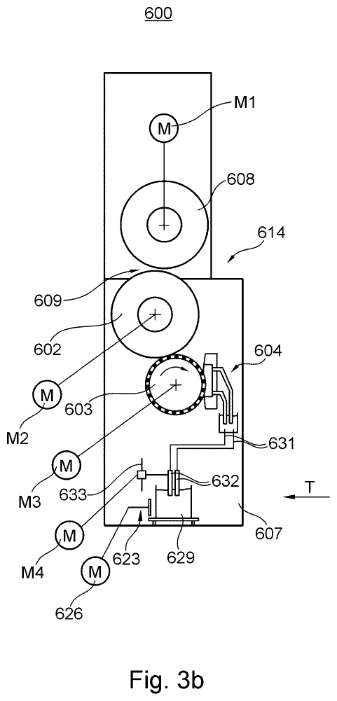

FIG. 4 a schematic illustration of an application unit with ink application from above;

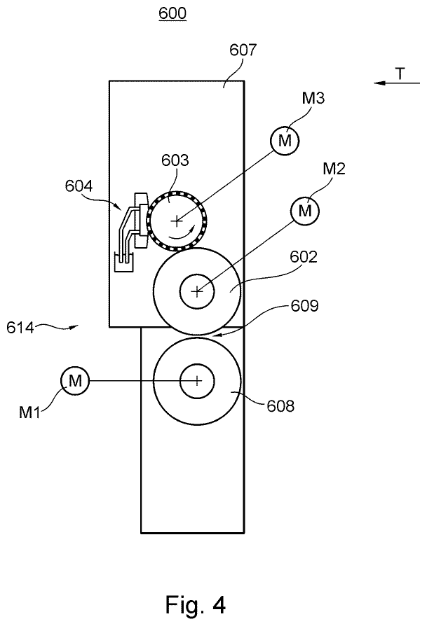

FIG. 5 a schematic illustration of the sheet delivery unit comprising a device for channeling out sheets as well as separation device arranged upstream from the sheet delivery unit;

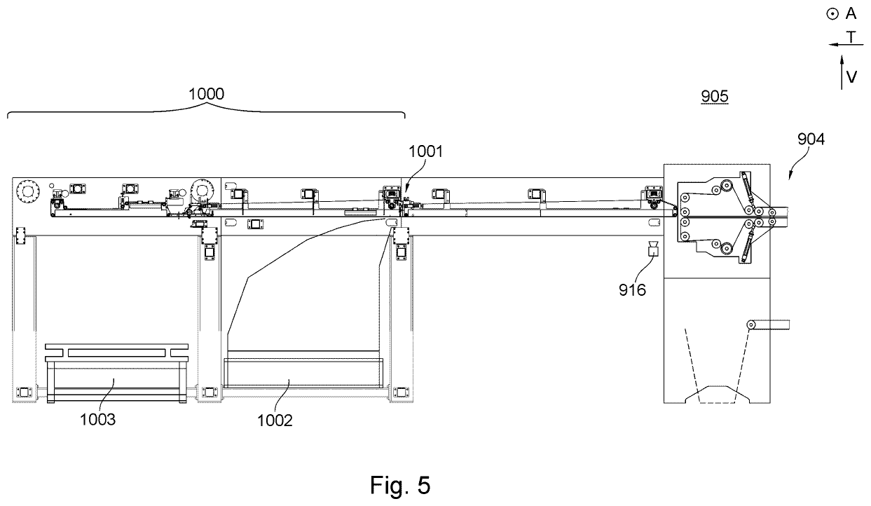

FIG. 6 a perspective illustration of an application unit comprising a storage device for changing an anilox roller;

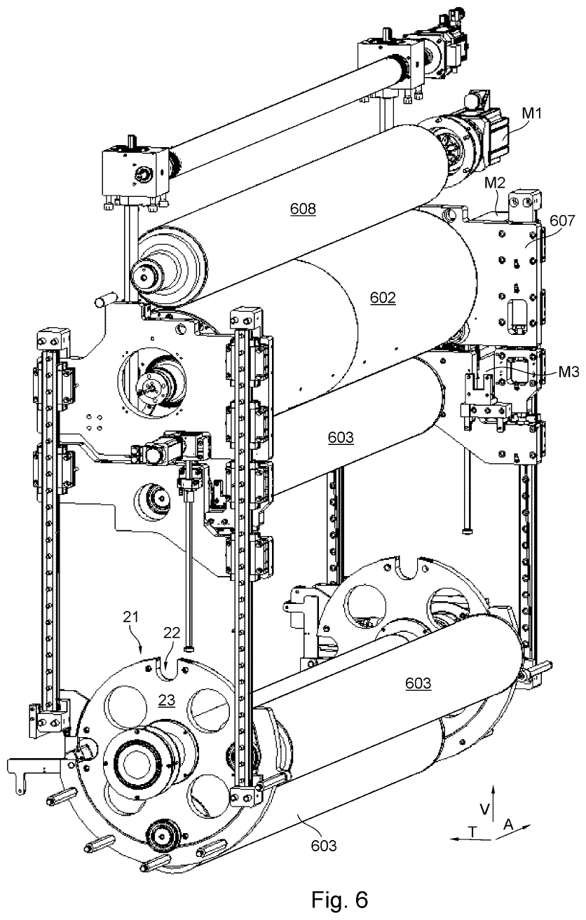

FIG. 7 a schematic illustration of a shaping unit comprising a device for changing the plate cylinders;

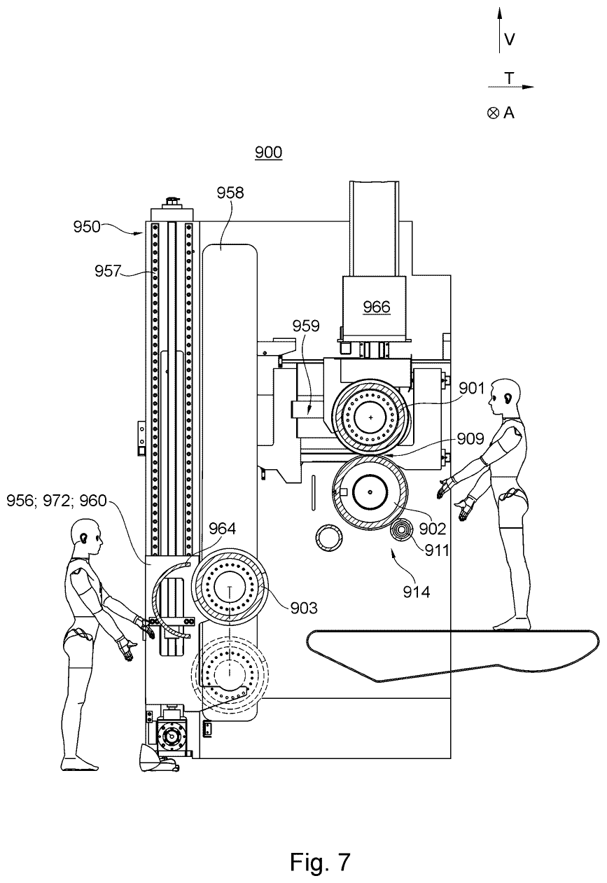

FIG. 8 a schematic illustration of a part of the processing machine in a preferred embodiment, wherein the shaping unit comprises a device for changing the plate cylinders, and showing the preferred embodiment, wherein a transport device is adjustable in the transport direction before the processing point, and wherein a transport means is pivotable in the transport direction after the processing point;

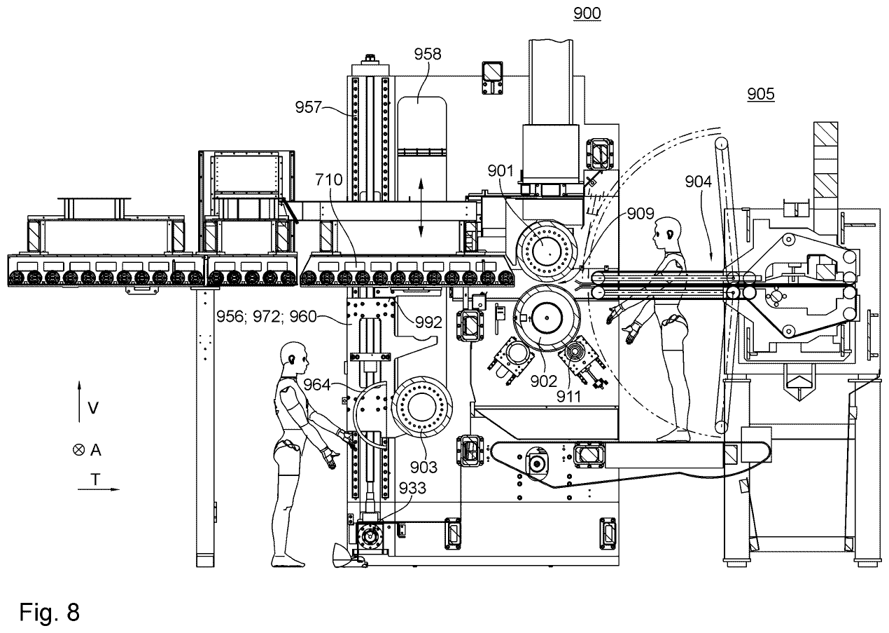

FIG. 9 a perspective illustration of a pushing-out device of an ink source; and

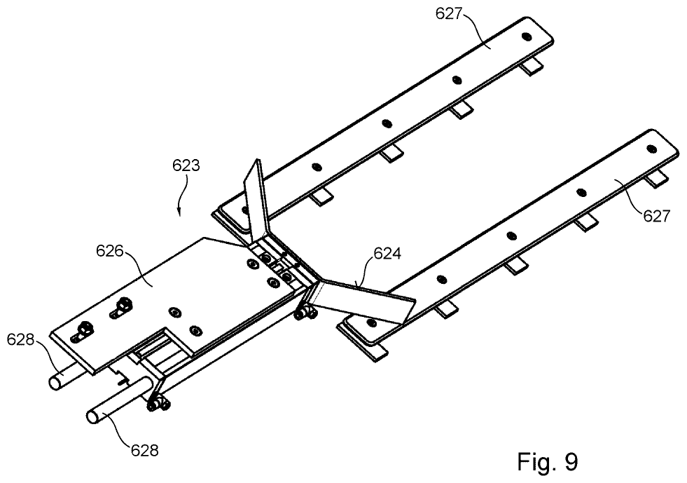

FIG. 10 an illustration of a pushing-out device of an ink source in a top view.

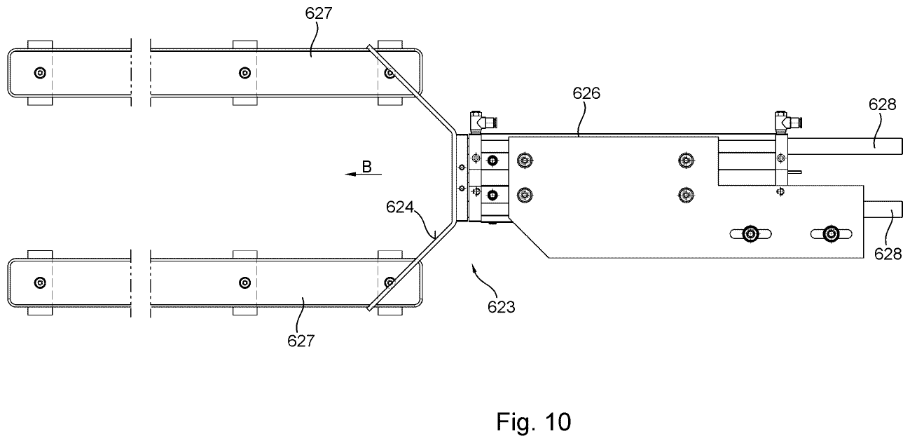

### DETAILED DESCRIPTION

A processing machine 01 is preferably designed as a printing machine 01 and/or as a shaping machine 01, in particular a die-cutting machine 01. The printing machine 01 is designed as a flexographic printing machine 01, for example.

The processing machine 01 is preferably referred to as a printing machine 01 when it comprises at least one printing mechanism 614 and/or at least one printing unit 600, in particular regardless of whether the machine comprises additional units for processing substrate 02. A processing machine 01 designed as a printing machine 01 also comprises, for example, at least one additional such unit 900, for example at least one shaping unit 900, which is preferably designed as a die-cutting unit 900, more preferably as a die-cutting device 900. The processing machine 01 is preferably referred to as a shaping machine 01 when it comprises at least one shaping mechanism 914 and/or at least one shaping unit 900, in particular regardless of whether it comprises additional units 600 for processing substrate 02. The processing machine 01 is preferably referred to as a die-cutting machine 01 when it comprises at least one die-cutting mechanism 914 and/or at least one die-cutting unit 900 and/or at least one die-cutting device 900, in particular regardless of whether it comprises additional units 600 for processing substrate 02. A processing machine 01 designed as a shaping machine 01 or die-cutting machine 01 also comprises, for example, at least one further unit 600 for processing substrate 02, for example at least one printing unit 600 and/or at least one printing mechanism 614. For example, the processing machine thus only comprises processing units 600 designed as application units 600 or processing units 900 only designed as shaping units 900 or both at least one processing unit 600; 900 designed as an application unit 600 and one designed as a shaping unit 900.

The processing machine 01 is preferably designed as a sheet processing machine 01, that is, as a processing machine 01 for processing sheet-format substrate 02, also referred to as sheets 02, in particular sheet-format print substrate 02. For example, the sheet processing machine 01 is designed as a sheet-fed printing machine 01 and/or as a sheet-fed shaping machine 01 and/or as a sheet-fed die-cutting machine 01. The processing machine 01 is further preferably designed as a corrugated cardboard sheet processing machine 01, that is, as a processing machine 01 for processing sheet-format substrate 02 or sheets 02 made of corrugated cardboard 02, in particular sheet-format print substrate 02 made of corrugated cardboard 02. The processing machine 01 is further preferably designed as a sheet-fed printing machine 01, in particular as a corrugated cardboard sheet printing machine 01, that is, as a printing machine 01 for coating and/or printing sheet-format substrate 02 or sheets 02 made of corrugated cardboard 02, in particular sheet-format print substrate 02 made of corrugated cardboard 02. The printing machine 01 is designed as a printing machine 01 that operates according to a printing forme-based printing method, for example.

Above and below, processing a substrate 02 describes altering at least one property of the relevant substrate 02 in particular with respect to the physical properties and/or material properties thereof, in particular the mass and/or shape and/or appearance thereof. In particular, die cutting, cutting, embossing, creasing, stripping and/or separating blanks constitute processing of the substrate 02. Preferably, printing, coating and/or priming are likewise considered processing. An existing substrate 02 can be further processed into an intermediate product or end product by processing operations. The processing machine 01 can therefore also, for example, be referred to as a processing machine for processing of preferably sheet-format substrate 02.

The processing machine 01 is designed so as to process substrate 02, preferably sheet-format substrate 02. The substrate 02 preferably includes at least one multiple-up. A multiple-up is preferably the region of the substrate 02 that is either designed as a product of the processing machine 01, in particular as an intermediate product for producing an end product, and/or, for example, is post-press processed and/or is designed to be post-press processed into a desired or required end product. The desired or required end product here, which is preferably generated by post-press processing of the respective multiple-up, is preferably a folder-type box and/or a packaging. Unless an explicit distinction is made, the term sheet-format substrate 02, in particular print substrate 02, specifically sheet 02, shall generally encompass any flat substrate 02 present in the form of sections, that is, including substrates 02 in tabular form or panel form, that is, including boards or panels. The sheet-format substrate 02 or sheet 02 thus defined is made, for example, of paper or paperboard, that is, as a sheet of paper or paperboard, or by sheets 02, boards, or optionally panels made of plastic, cardboard, glass, or metal. More preferably, the substrate 02 is corrugated cardboard 02, in particular corrugated cardboard sheets 02. The at least one sheet 02 is preferably designed as corrugated cardboard 02. A thickness of a sheet 02 shall preferably be understood to mean a dimension orthogonal to a largest surface area of the sheet 02. This largest surface area is also referred to as the main surface area. For example, the thickness of the sheets 02 is at least 0.1 mm, more preferably at least 0.3 mm, and still more preferably at least 0.5 mm. Considerably greater thicknesses are also customary, especially in the case of corrugated cardboard sheets 02, for example at least 4 mm or also 10 mm and more. Corrugated cardboard sheets 02 are relatively stable and are therefore not very flexible. Corresponding adjustments of the processing machine 01 therefore facilitate the processing of sheets 02 of great thickness. For example, the sheet-format substrate 02, in particular a sheet 02, has a length of at least 50.0 cm (fifty centimeters), preferably of at least 52.0 cm, more preferably of at least 60.0 cm, more preferably of at least 100.0 cm (one hundred centimeters), preferably of at least 120.0 cm (one hundred twenty centimeters), more preferably of at least 130.0 cm (one hundred thirty centimeters), more preferably of at least 150.0 cm (one hundred fifty centimeters). For example, the substrate 02 has a maximum length of 200.0 cm, preferably of no more than 180.0 cm, in particular no more than 170.0 cm. The length preferably describes the length of the substrate 02 along the transport direction T within the processing machine 01, that is, preferably the distance between the leading end thereof and the trailing end thereof. For example, the sheet-format substrate 02, in particular a sheet 02, has a width of at least 50.0 cm, preferably of at least 60.0 cm, more preferably of at least 100.0 cm (one hundred centimeters), more preferably of at least 120.0 cm (one hundred twenty centimeters), more preferably of at least 130.0 cm (one hundred thirty centimeters), more preferably of at least 150.0 cm (one hundred fifty centimeters), still more preferably at least 200 cm (two hundred centimeters), still more preferably at least 250 cm (two hundred fifty centimeters), still more preferably at least 280 cm (two hundred eighty centimeters). For example, the maximum width of the substrate 02 is 350.0 cm, in particular 300.0 cm. The width preferably describes the width of the substrate 02 along the working width, that is, in the transverse direction A, within the processing machine 01.

The respective, preferably the at least one, sheet 02 is preferably made of paper or cardboard or paperboard. According to DIN 6730, paper is a flat material, consisting mainly of fibers derived from vegetable sources, which is formed by the dewatering of a fiber suspension on a sieve. In the process, a card web is created, which is subsequently dried. The basis weight of paper is preferably a maximum of 225 g/m². According to DIN 6730, cardboard is a flat material, consisting mainly of fibers derived from vegetable sources, which is formed by the dewatering of a fiber suspension on a sieve or between two sieves. The fiber structure is compressed and dried. Cardboard is preferably manufactured from cellulose by gluing or pressing the cellulose together. Cardboard is preferably designed as solid board or corrugated cardboard 02. Above and below, corrugated cardboard 02 is cardboard made of one or more layers of corrugated paper that is glued to one layer or between multiple layers of another, preferably smooth, paper or cardboard. The basis weight of cardboard is preferably more than 225 g/m². Above and below, the term paperboard preferably refers to a sheet material that is preferably primed on one side and made of paper, preferably having a basis weight of at least 150 g/m² and no more than 600 g/m². Paperboard preferably has high strength relative to paper. A leading edge is preferably an edge of the substrate 02 which, along the transport path in the processing machine 01, is the first edge of the substrate 02 to come in contact with the particular units 100; 300; 600; 700; 900; 1000, and in particular with the processing points 609; 909. A trailing edge is a last edge of the substrate 02 along the transport path.

The processing machine 01 comprises several units 100; 300; 600; 700; 900; 1000. A unit in this context shall preferably be understood to mean a group of devices that cooperate functionally, in particular in order to carry out a preferably self-contained processing operation of sheets 02. At least two, for example, and preferably at least three, and more preferably all of the units 100; 300; 600; 700; 900; 1000 are designed as modules 100; 300; 600; 700; 900; 1000 or at least each is assigned to such a module. A module in this context shall in particular be understood to mean a respective unit or a structure made up of multiple units, which preferably comprises at least one transport means and/or at least a dedicated drive controllable by open loop and/or closed loop control, and/or as an independently functioning module and/or as an individually manufactured and/or separately assembled machine unit or functional assembly. A dedicated drive, controllable by open loop and/or closed loop control, of a unit or module shall in particular be understood to mean a drive that is used to power the movements of components of this unit or module and/or that is used to transport substrate 02, in particular sheets 02, through this particular unit or module and/or through at least one operating zone of this particular unit or module and/or that is used to directly or indirectly drive at least one component of the particular unit or module which is intended for contact with sheets 02. The dedicated drive of a unit or module which can be controlled by open loop and/or closed loop control is preferably designed to drive movements of components of this unit or module and/or designed to effect a transport of substrate 02 and/or designed to directly or indirectly drive at least one component of the particular unit or module which is intended for contact with sheets 02. These drives of the units 100; 300; 600; 700; 900; 1000 of the processing machine 01 are preferably embodied, in particular, as closed loop position-controlled electric motors. By arranging and/or interlinking the units 100; 300; 600; 700; 900; 1000, the processing machine 01 preferably has a non-stop substrate stream, in particular of the sheet-format substrates 02, from the first unit 100; 300; 600; 700; 900; 1000 to the last unit 100; 300; 600; 700; 900; 1000 of the processing machine 01, in particular at least between the processing units 600; 900.

Each unit 100; 300; 600; 700; 900; 1000 preferably comprises at least one open loop drive controller and/or at least one closed loop drive controller, which is assigned to the respective at least one drive of the particular unit 100; 300; 600; 700; 900; 1000. The open loop drive controllers and/or closed loop drive controllers of the individual units 100; 300; 600; 700; 900; 1000 can preferably be operated individually and independently of one another. More preferably, the open loop drive controllers and/or closed loop drive controllers of the individual units 100; 300; 600; 700; 900; 1000 are linked and/or can be linked in terms of circuitry, in particular by means of at least one BUS system, to one another and/or to a machine control system of the processing machine 01 in such a way that coordinated open loop and/or closed loop control of the drives of several or all units 100; 300; 600; 700; 900; 1000 of the processing machine 01 is and/or can be carried out. Accordingly, the individual units 100; 300; 600; 700; 900; 1000 and/or in particular modules 100; 300; 600; 700; 900; 1000 of the processing machine 01 can be and/or are operated preferably so as to be electronically synchronized with one another, at least with respect to the drives thereof, in particular by means of at least one virtual and/or electronic master axis. Preferably, the master axis, preferably the virtual master axis, defines a machine cycle. For this purpose, the virtual and/or electronic master axis is preferably specified, for example by a higher-level machine control system of the processing machine 01. As an alternative or in addition, the individual units 100; 300; 600; 700; 900; 1000 of the processing machine 01 are and/or can be mechanically synchronized with one another, for example, at least with respect to the drives thereof. Preferably, however, the individual units 100; 300; 600; 700; 900; 1000 of the processing machine 01 are mechanically decoupled from one another, at least with respect to the drives thereof.

The spatial area provided for the transport of substrate 02, which the substrate 02, if the same is present, at least temporarily occupies, is the transport path. The transport path is preferably defined by at least one device for guiding the substrate 02 in an operating state of the processing machine 01. Unless described otherwise, each of the units 100; 300; 600; 700; 900; 1000 of the processing machine 01 is preferably characterized in that the section of a transport path provided for a transport of substrate 02, in particular sheets 02, which is defined by the respective unit 100; 300; 600; 700; 900; 1000, is at least substantially flat, and more preferably completely flat. A substantially flat section of the transport path provided for the transport of substrate 02, in particular sheets 02, in this context shall be understood as a section that has a minimum radius of curvature of at least 2 meters, more preferably at least 5 meters, still more preferably at least 10 meters, and still more preferably still at least 50 meters. A completely flat section has an infinitely large radius of curvature and is thus likewise substantially flat and therefore likewise has a minimum radius of curvature of at least 2 meters. Unless described otherwise, each of the units 100; 300; 600; 700; 900; 1000 of the processing machine 01 is preferably characterized in that the section of the transport path provided for the transport of sheets 02, which is defined by the respective unit 100; 300; 600; 700; 900; 1000, extends at least substantially horizontally, and more preferably exclusively horizontally. This transport path preferably extends in a direction T, in particular in the transport direction T. A substantially horizontal transport path provided for the transport of sheets 02 means, in particular, that within the entire area of the particular unit 100; 300; 600; 700; 900; 1000, the provided transport path only has one or more directions that deviate by no more than 30°, preferably no more than 15°, and more preferably no more than 5° from at least one horizontal direction.

The direction of the transport path, in particular the transport direction T, is in particular the direction in which the sheets 02 are transported at the point at which the direction is measured. The transport direction T provided in particular for a transport of sheets 02 is the direction T that is preferably oriented at least substantially, and more preferably entirely, horizontally and/or that preferably points from a first unit 100; 300; 600; 700; 900; 1000 of the processing machine 01 to a last unit 100; 300; 600; 700; 900; 1000 of the processing machine 01, in particular from a sheet feeder unit 100 or a substrate feed device 100 on the one hand to a delivery unit 1000 or a substrate output device 1000 on the other hand, and/or that preferably points in a direction in which the sheets 02 are transported, apart from vertical movements or vertical components of movements, in particular from a first point of contact with a unit 300; 600; 700; 900; 1000 of the processing machine 01 that is arranged downstream from the substrate feed device 100 or a first point of contact with the processing machine 01 to a last point of contact with the processing machine 01. Regardless of whether the infeed device 300 is an independent unit 300 or module 300 or is an integral part of the substrate feed device 100, the transport direction T is preferably the direction T in which a horizontal component of a direction points, which is oriented from the infeed device 300 to the substrate output device 1000.

A direction A, preferably a transverse direction A, preferably also referred to as an axial direction A, is preferably a direction A that is oriented orthogonally to the transport direction T of the sheets 02 and/or orthogonally to the intended transport path of the sheets 02 through the at least one application unit 600 and/or through the at least one shaping unit 900 and/or through the at least one sheet delivery unit 1000. The transverse direction A is preferably a horizontally oriented direction A. A working width of the processing machine 01 and/or of the at least one application unit 600 and/or of the at least one shaping unit 900 and/or of the at least one sheet delivery unit 1000 is preferably a dimension that preferably extends orthogonally to the intended transport path of the sheets 02 through the at least one application unit 600 and/or the at least one shaping unit 900 and/or the at least one sheet delivery unit 1000, more preferably in the transverse direction A. The working width of the processing machine 01 preferably corresponds to a maximum width that a sheet 02 may have in order to still be able to be processed by the processing machine 01, that is, in particular a maximum sheet width that can be processed by the processing machine 01. The width of a sheet 02 shall, in particular, be understood to mean the dimension thereof in the transverse direction A. This preferably applies regardless of whether this width of the sheet 02 is greater than or less than a horizontal dimension of the sheet 02 orthogonal thereto, which more preferably represents the length of this sheet 02. The working width of the processing machine 01 preferably corresponds to the working width of the at least one application unit 600 and/or of the at least one shaping unit 900 and/or of the at least one sheet delivery unit 1000. The working width of the processing machine 01, in particular sheet processing machine 01, is preferably at least 100 cm, more preferably at least 150 cm, still more preferably at least 160 cm, still more preferably at least 200 cm, and still more preferably at least 250 cm.

A vertical direction V preferably denotes a direction that is parallel to the normal vector of a plane spanned by the transport direction T and the transverse direction A. For example, in the region of the shaping device 900, the vertical direction V is preferably oriented so as to point from the print substrate 02 toward a plate cylinder 901 of the shaping device 900.

The processing machine 01 preferably comprises at least one substrate feed device 100, which more preferably is designed as a unit 100, in particular a substrate feed unit 100, and/or as a module 100, in particular a substrate feed module 100. In particular in the case of a sheet processing machine 01, the at least one substrate feed device 100 is preferably designed as a sheet feeder 100 and/or sheet feeder unit 100 and/or sheet feeder module 100. A sheet 02 to be processed is preferably arranged in a pile within a piling region of the substrate feed device 100 at the beginning of a processing job and is conveyed from there through the processing machine 01. The at least one substrate feed unit 100 is preferably connected to at least one control unit, which preferably controls at least one element of the substrate feed unit 100.

The at least one substrate feed device 100 preferably comprises at least one front stop and/or at least one lateral stop and/or at least one rear stop at the piling region, which more preferably are movable toward and away from the at least one substrate 02 of the pile and act as a sheet jogger. For example, as an alternative, the position of at least one of the stops is fixed, for example of the front stop. The substrate feed unit 100 preferably comprises at least one receiving means, preferably suction means, for removing the at least one substrate 02 from the pile, in particular by applying suction thereto and transporting it away in the suctioned state. Preferably, at least one blower device, which is directed at the pile in the piling region, is provided to support the process, in particular for lifting at least one edge of an uppermost substrate 02 of the pile. Preferably, air is blown by this blower device laterally against the pile, preferably in the region of the uppermost substrate 02 of the pile, whereby, for example, a leading edge or trailing edge or side edge of at least one substrate 02 is lifted and/or loosened from other substrates 02 of the pile. Preferably, at least one stream feeder is arranged downstream from the piling region of the substrate feed device 100. This stream feeder is preferably designed so that substrates 02 pulled off the pile are transported in imbricated arrangement in the transport direction T. This is preferably achieved by means of at least one conveying means, preferably a conveyor belt and/or transport roller. The substrates 02 are preferably fed to an infeed unit 300 in imbricated arrangement or individually.

The processing machine 01 preferably comprises at least one unit 300, preferably an infeed device 300, which is more preferably designed as an infeed unit 300 and/or infeed module 300. In a preferred embodiment, the at least one infeed device 300, also referred to as an infeed, is designed as an integral part of the substrate feed device 100. The substrate feed device 100 preferably comprises the infeed unit 300. The alignment of the at least one substrate 02 is preferably carried out in the infeed unit 300.

The at least one infeed unit 300 preferably comprises a storage area 166 in which substrates 02, if the same are present, are present in the form of at least one pile, this being the feeder pile 104, or in imbricated arrangement, that is, overlapping with at least one edge. If the stream feeder is arranged upstream, preferably a pile of substrate 02, this being the feeder pile 104, is preferably temporarily formed in the storage area 166. Preferably, the at least one substrate feed device 100, in particular the infeed unit 300 thereof, comprises at least one front stop and/or at least one lateral stop and/or at least one rear stop, which preferably aligns the at least one substrate 02 in the storage area 166. For example, at least one stop is fixed or movable and can be moved toward the substrate 02 and/or away from the substrate 02. Preferably, the at least one substrate 02 is aligned in the at least one substrate feed device 100, in particular in the infeed unit 300 thereof, by means of the at least one fixed or movable stop. Preferably, the substrate feed device 100 and/or the infeed unit 300 separate the substrates 02 so that the substrates 02 are transported consecutively, preferably spaced apart from one another, by the succeeding units 600; 700; 900; 1000 of the processing machine 01.

The at least one substrate feed device 100, preferably the at least one infeed unit 300 of the substrate feed device 100, preferably comprises at least one acceleration means, preferably at least one primary acceleration means and/or at least one secondary acceleration means, for accelerating the substrate 02 to the processing speed. Preferably, at least one acceleration means of the substrate feed unit 100, in particular of the infeed unit 300 thereof, is designed as a primary acceleration means, which pulls an individual substrate 02 off the storage area 166 and/or accelerates the individual substrate 02 to a processing speed of the processing units 600; 900. In a preferred embodiment, the at least one primary processing means is at least one conveyor belt; alternatively, for example, it is a rocking gripper. The substrate 02 is preferably pulled off the pile in the storage area 166, more preferably the bottommost substrate 02 of the feeder pile 104 is pulled off. For example, as an alternative to pulling substrate off the pile, in particular when the storage area 166 is designed to store the substrates 02 in imbricated arrangement without the formation of a pile, a foremost substrate 02 of the imbricated arrangement is pulled off by the at least one acceleration means. The at least one acceleration means, in particular the at least one primary acceleration means, is preferably connected to a control unit, which preferably activates or deactivates the acceleration means and/or which preferably sets the speed of the acceleration means. For example, the at least one secondary acceleration means is designed so as to align a substrate 02 in the circumferential direction, that is, in the transport direction T, in particular by adapting the speed of the substrate by acceleration, preferably based on at least one sensor 164 detecting the substrate 02.

For example, the processing machine 01 comprises at least one unit designed as a conditioning device, in particular a conditioning unit, which is more preferably designed as a module, in particular as a conditioning module. Such a conditioning device is designed, for example, as a pre-processing device or as a post-processing device. The processing machine 01 preferably comprises at least one unit designed as a pre-processing device, in particular a pre-processing unit, which more preferably is designed as a module, in particular as a pre-processing module, and represents a conditioning device. The processing machine 01 preferably comprises at least one post-processing device.

The processing machine 01 comprises at least one processing unit 600; 900. The at least one processing unit 600; 900 is preferably arranged downstream from the substrate feed unit 100. The processing machine 01 comprises at least two processing units 600; 900, which preferably carry out processing operations that differ from one another. At least one processing unit 900 of the processing machine 01 is designed as a shaping unit 900, preferably as a die-cutting unit 900, which is designed as a rotary die-cutting device 900. The at least one processing unit 900 designed as a shaping unit 900 is designed as a rotary die-cutting device 900. The processing methods carried out by the at least one shaping unit 900 are, for example, die cutting, creasing, embossing, perforating and/or stripping. Preferably, the at least one shaping unit 900 is designed to carry out at least two of the processing methods. For this purpose, the unit comprises at least two different tools.

The processing machine 01 comprises at least one, preferably at least two, preferably at least four processing units 600 designed as application units 600. Preferably, at least one processing unit 900 succeeding the at least one application unit 600 is designed as a shaping unit 900, in particular die-cutting unit 900.

In a preferred embodiment, exactly one shaping device 900, in particular die-cutting device 900 and/or rotary die-cutting device 900, is provided. In an alternative embodiment, the processing machine 01 comprises at least two shaping units 900, which are designed to carry out differing processing methods. For example, one shaping unit 900 comprises a die-cutting tool, while another shaping unit comprises a creasing tool and/or an embossing tool and/or a stripping tool. For example, the processing machine comprising multiple shaping units does not additionally comprise an application unit or comprises at least one application unit. When, above and below, the at least one shaping unit 900 is described, in particular by being designed as a die-cutting unit 900, this description shall likewise be applied to further shaping units, such as, for example, a creasing unit, an embossing unit or a stripping unit. The tool is preferably adapted and/or adaptable to the respective processing method to be carried out.

The processing machine 01 comprises at least one, preferably at least two, more preferably at least four, more preferably at least six, for example eight, processing units 600 designed as application units 600. The at least one application unit 600 is preferably arranged and/or designed according to the function and/or application method. The at least one application unit 600 is preferably used to apply at least one respective application fluid or coating agent over the entire surface area and/or a portion of the surface area of the sheets 02. One example of an application unit 600 is a printing unit 600 or printing module 600, which is used in particular for applying printing ink and/or ink onto substrate 02, in particular sheets 02. In particular, the at least one application unit 600 is designed to apply application fluid, preferably printing ink and/or ink, for example over the entire surface area and/or a portion of the surface area of the sheets 02. Above and below, an optionally provided priming unit and/or an optional varnishing unit may also be considered to be such an application unit 600 or printing unit 600. Preferably, at least one substrate 02, in particular sheet 02, is printed and/or coated and/or primed in the at least one forward processing unit 600, which is preferably designed as an application unit 600. The at least one application unit 600 preferably comprises the at least one application mechanism 614. At least one first application unit 600 in the transport direction T is preferably designed as a priming unit. At least one last application unit 600 in the transport direction T is preferably designed as a varnishing unit. Preferably, at least one, preferably at least four application units 600, which are preferably arranged downstream from the priming unit and/or which are arranged upstream from the varnishing unit, are designed as printing units 600. If the at least one application unit 600 is present, the at least one shaping unit 900 is preferably arranged downstream from the at least one application unit 600, preferably downstream from all application units 600 of the processing machine 01.

Regardless, in particular, of the function of the application fluid that can be applied by the application units 600, these units can preferably be distinguished in terms of the application method thereof. One example of an application unit 600 is a forme-based application unit 600, which comprises, in particular, at least one fixed, physical, and preferably exchangeable printing for me. Forme-based application units 600 preferably operate according to a planographic printing process, in particular an offset planographic printing process, and/or according to a gravure printing process, and/or according to a letterpress printing process, in particular preferably according to a flexographic printing process. The corresponding application unit 600 is then a flexographic application unit 600 or flexographic printing unit 600, for example, in particular a flexographic application module 600 or flexographic printing module 600. The at least one application unit 600 is preferably designed as a forme-based application unit 600, more preferably as a flexographic application unit 600. In a particularly preferred embodiment, the flexographic application unit 600 comprises a flexographic priming mechanism or a flexographic printing mechanism or a flexographic coating mechanism.

The at least one application unit 600 comprises a plate cylinder 602. The plate cylinder 602 is preferably driven by means of a drive M2, preferably dedicated drive. An impression cylinder 608 is preferably assigned to the plate cylinder 602. The processing point 609 designed as an application point 609 is located between the plate cylinder 602 and the impression cylinder 608. The impression cylinder is driven by means of a drive M1, preferably by means of a dedicated drive or a drive of the printing unit 600 or, in an alternative design, in addition to the plate cylinder 602 by means of the drive M1 of the plate cylinder 602. The plate cylinder 602 and the impression cylinder 608 are preferably each designed as a cylinder 602 or cylinder 608.

Moreover, the at least one application unit 600, in particular in the case of a flexographic printing unit 600, preferably comprises at least one supply roller 603, which is preferably designed as an anilox roller 603. During operation, the plate cylinder 602 is supplied with printing fluid via the supply roller 603. For this purpose, the supply roller 603 is preferably in contact with a chamber doctor blade 604.

The at least one application unit 600 preferably comprises at least one supply system of application fluid, preferably printing color and/or ink and/or varnish and/or primer. The supply system is preferably designed to feed the application fluid to the rotating rollers and/or cylinders of the application mechanism 614, that is, preferably to the anilox roller 603. The chamber doctor blade 604 is preferably an integral part of the supply system.

The chamber doctor blade 604 preferably comprises at least one doctor blade and preferably additionally at least one intermediate reservoir of application fluid. The intermediate reservoir is supplied, for example, with application fluid from a fluid source 629 of the supply system. The application fluid is preferably applied by the chamber doctor blade 604 to the supply roller 603.

Preferably, at least one fluid source 629 is provided on the at least one application unit 600. Preferably, the at least one fluid source 629 is designed so as to be removable from the application unit 600. The at least one fluid source 629 is preferably a source of the application fluid, that is, of the printing color and/or ink and/or varnish and/or primer of the application unit 600. For example, the fluid source 629 is designed as an ink bucket. Preferably, a volume, in particular fill volume, of the fluid source 629 for application fluid is greater than the amount of application fluid that is required for a single processing job. During a use of the fluid source 629 in the application unit 629, this fluid source is arranged in an operative position. In a preferred embodiment, the at least one fluid source 629 is arranged so as to be accessible for an operator, in particular when the processing machine 01 is locked. The at least one fluid source 629 is particularly preferably arranged on an outer side of a housing of the application unit 600. The housing preferably represents a safety cover of the application mechanism 614 and, for example, comprises a lockable door.

The supply system preferably comprises at least one line 631 of application fluid, preferably at least one line 631 designed as a feed line, and/or at least one line 631 designed as a drain line. The at least one line 631 is designed to cooperate with the fluid source 629, if the same is present, arranged in the operative position for providing application fluid, in particular so as to deliver the application fluid to the chamber doctor blade 604 and/or anilox roller 603. The at least one line 631 preferably conducts the application fluid into the application mechanism 614, in particular into the housing. The at least one line 631 is preferably functionally connected to at least one pump device.

The at least one line 631 preferably comprises at least one lance 632, preferably at the end thereof facing the fluid source 629. The at least one feed line and the at least one drain line preferably each comprise a lance 632. For example, the lance 632 is a rigid tubular component. The at least one lance 632 is preferably designed to be dipped into the fluid source 629, in particular into the application fluid present therein, and to ensure delivery of the application fluid. In a first, lowered position, the at least one lance 632 is preferably arranged, preferably at least with a tip of the lance 632, so as to enter a volume of the fluid source 629, if the same is present, arranged in the operative position.

In a preferred embodiment, the at least one lance 632 is, preferably the at least two lances 632 are, designed so as to be displaceable, particularly preferably vertically displaceable. The at least one lance 632 preferably has at least the first, lowered position and at least one second, raised position. These positions are preferably spaced apart from one another in the vertical direction V. In the second position, the at least one lance 632, in particular with the tip thereof, is preferably arranged outside the volume of the at least one fluid source 629, if the same is present. The at least one lance 632 is preferably displaceable along at least one guide 633, preferably linear guide, for example a rail system, for displacement between the at least two positions. Preferably, the at least one lance 632 has at least one attachment, preferably the at least two lances 632 have a shared attachment, which is displaceable along the at least one guide 633. Preferably, at least one drive M4 is provided, which has a drive connection to the at least one lance 632 and displaces the same between the at least one first and second positions. For example, the drive M4 of the at least one lance 632 is a pneumatic or hydraulic drive or an electric drive. The at least one drive M4 of the at least one lance 632 preferably has a data connection to at least one control unit of the processing machine 01, in particular to the control unit which controls by open loop control and/or closed loop control at least one cleaning process, in particular washing process, of the application unit 600.

The at least one fluid source 629 is preferably arranged in the operative position during the processing operation of the application unit 600, in which the fluid source preferably can be or is functionally connected to the at least one line 631, in particular the at least one lance 632. Preferably, the at least one fluid source 629 can be taken out of the operative position thereof. A position of the at least one fluid source 629 spaced apart from the operative position is a backed-away position, preferably spaced apart in a movement direction B. The at least one fluid source 629 is preferably situated on a ground surface that allows the fluid source 629 to slide across the same. For example, at least one, preferably at least two sliding rails 627 are arranged beneath the at least one fluid source 629, along which the at least one fluid source 629 can be displaced between the operative position and the backed-away position. For example, the at least one fluid source 629 is alternatively situated on the floor of the machine hall.

The at least one application unit 600 preferably comprises at least one pushing-out device 623 having at least one contact surface 624. The at least one pushing-out device 623 is preferably designed to displace the at least one fluid source 629, if the same is present, from the operative position into the backed-away position, in particular in the movement direction B. For example, the at least one pushing-out device 623 pushes the at least one fluid source 629 laterally, preferably in the transverse direction A, out of the operative position. The movement direction B is preferably a linear direction B, which particularly preferably is horizontally oriented, which, for example, is directed so as to point away from the housing of the application unit 600 in or counter to the transverse direction A.

The at least one pushing-out device 623 comprises the at least one contact surface 624, which can preferably establish operative contact with the fluid source 629 or, if the same is present, establishes operative contact. A normal vector of the contact surface 624, which is thus situated perpendicular to the contact surface 624, is preferably directed toward the fluid source 629. Preferably, the at least one contact surface 624 has at least one surface region that has a normal vector having a directional component in the movement direction B. For example, at least one normal vector of a first surface region is parallel to the movement direction B. In addition or as an alternative, at least one normal vector of a second surface region is, for example, parallel to a direction different from the movement direction B. Preferably, the first and/or second surface regions of the contact surface 624 form a plane that is spanned by the vertical direction V and a horizontal direction different from the movement direction B.

The at least one contact surface 624 preferably has at least one first, deactivated position and at least one second, activated position. When the at least one contact surface 624 is arranged in the first, deactivated position, the at least one pushing-out device 623 is preferably designed so as to enable the operative position for the arrangement of the fluid source 629. When the at least one contact surface 624 is arranged in the second, activated position, the at least one pushing-out device 623 is preferably designed so as to block the operative position for the arrangement of the fluid source 629. In the deactivated position, the at least one contact surface 624 is preferably arranged spaced apart from the operative position of the fluid source 629, for example recessed in a housing wall of the application unit 600. The at least one contact surface 624 is preferably arranged in the deactivated position while a processing job is being completed by the application unit 600. The at least one pushing-out device 623 preferably comprises at least one guide 628, preferably a guide rail 628, more preferably a linearly oriented guide rail 628, for displacing the at least one contact surface 624 from the deactivated position into the activated position and/or vice versa.

The at least one pushing-out device 623 preferably comprises at least one actuating means 626, preferably an actuating cylinder 626, for displacing the at least one contact surface 624 from the deactivated position into the activated position and/or vice versa. Particularly preferably, the at least one actuating means 626 is a pneumatic or hydraulic actuating cylinder 626. As an alternative, the at least one actuating means 626 is, for example, an electric drive means, for example, comprising an electric motor.

The at least one actuating means 626 of the at least one pushing-out device 623 preferably has a data connection to at least one control unit of the processing machine 01. The at least one actuating means 626 preferably has a data connection to a control unit of the processing machine 01 controlling by open loop control or closed loop control a modification process, designed as a cleaning process, of the at least one application unit 600. Preferably in addition or as an alternative, the at least one actuating means 626 has a data connection to a control unit of the processing machine 01 controlling by open loop control or closed loop control a modification process of the at least one shaping unit 900. The at least one actuating means 626 of the at least one pushing-out device 623 is preferably activated or controlled so as to be matched to at least one modification process of the at least one shaping unit 900, in particular by the at least one control unit. In a particularly preferred embodiment, the at least one actuating means 626 of the at least one pushing-out device 623 and the at least one drive M4 of the at least one lance 632 have a data connection to at least one control unit of the processing machine 01 that matches the activation of the at least one actuating means 626 and of the at least one drive M4 to one another. Particularly preferably, the at least one actuating means 626 of the at least one pushing-out device 623 and the at least one drive M4 of the at least one lance 632 are activated or controlled so as to be matched to one another by the at least one control unit of the processing machine 01.

The supply roller 603 preferably has a well structure on the outer cylindrical surface thereof, in particular on the outer cylindrical surface of the roller body thereof. The supply roller 603 is preferably designed as a cylinder 603. The at least one supply roller 603 is preferably arranged so as to be in contact and/or arranged in such a way that it can be brought in contact with a plate cylinder 602. The application fluid is preferably transferred from the anilox roller 603, which is set against the plate cylinder 602, to the plate cylinder 602. Preferably, a supply roller drive M3 designed as a drive M3 of the supply roller 603 is connected and/or can be connected to the supply roller 603 via a releasable connection, for example by means of a coupling. This connection is preferably released when the supply roller 603 is to be placed into a storage device 21. The at least one storage device 21 preferably comprises at least two, more preferably at least three, still more preferably at least four, and still more preferably exactly four storage receptacles 22 for receiving a respective supply roller 603. In this way, at least one supply roller 603 can always be kept available in the vicinity of the intended usage site if a presently used supply roller 603 is to be replaced. Such a replacement usually takes place, for example, when a succeeding processing job requires a smaller or greater amount of application fluid per surface area. The storage device 21 preferably comprises at least one movable repositioning device 23, by means of which the at least two storage receptacles 22 can be moved and arranged in different storage positions. The storage device 21 is thus suitable for replacing the anilox roller 603 quickly and easily. For changing the anilox roller 603, the anilox roller 603 to be replaced is preferably guided from the working position thereof to at least one free storage position of the repositioning device 23, and at least one anilox roller 603 to be installed is moved from the storage position thereof in the repositioning device 23 to the working position. This change process is preferably controlled by means of the machine control system. In particular in conjunction with a device for changing 950 die-cutting cylinders 901; 903, an expedited job change can be created. Both devices thus crucially contribute to expedited job changes of the processing machine 01. The cylinders 602, 603, 608 are preferably supported by a frame 607.

A preferred first embodiment of the flexographic application mechanism 614 is intended to provide application fluid from beneath onto, for example to print, substrate 02, in particular sheets 02 and/or print substrate 02. In this preferred first embodiment of the flexographic application mechanism 614, the plate cylinder 602 is preferably arranged beneath the impression cylinder 608. In an alternative embodiment, the sheets 02 are printed from above. The printing unit 600 is then preferably designed in a mirror-inverted order and has design adaptations. The sheets 02 are preferably die-cut on the opposite side to the print image. This is why printing from beneath is the preferred embodiment.

The plate cylinder 602 of the at least one application unit 600 can preferably be moved relative to the supply roller 603 by means of servo drives and/or relative to the impression cylinder 608 by means of servo drives. In this way, a corresponding application point 609 can preferably be adapted to different thicknesses of substrate 02 to be processed.

The at least one printing plate of the plate cylinder 602 is preferably adapted to the processing job carried out. A need therefore exists to change the at least one printing plate when a change to another processing job occurs. The printing plate is preferably changed in an automated manner. The printing plate can be provided or is provided with a print image. Using holding means, for example mounting arms of the printing plate, in cooperation with spring elements of the cylinder 602, the printing plate can preferably be attached to the plate cylinder 602, preferably by the generation of a retaining force. For example, the printing plate is suspended and/or clamped in a channel in the outer cylindrical surface of the cylinder 602. The printing plate is detached from the plate cylinder 602 by removing the retaining force, for example, using a preferably pneumatically actuatable actuating means. The at least one application unit 600 preferably comprises at least one printing plate magazine. The printing plate magazine preferably comprises at least one receiving device for a printing plate to be installed and at least one receiving device for a printing plate to be replaced. So as to remove a used printing plate and/or so as to provide a new printing plate in the receiving devices, the receiving devices are preferably accessible from the side of the printing plate magazine that faces away from the plate cylinder 602 or from a side extending parallel to the transport direction of the substrate 02. The printing plate magazines preferably extend across the entire working width of the processing machine 01 and/or more preferably the receiving devices are fitted with printing plates across the region of the working width necessary in the particular processing job. The printing plate magazine can preferably be set against the plate cylinder 602, for example, by means of pivoting, whereby the accessibility is further increased.

In a working position of the printing plate magazine, that is, when the same is set against the plate cylinder 602, preferably at least one printing plate between the receiving devices and the plate cylinder 602 can be replaced, preferably by either removing a printing plate that is no longer required for carrying out a print job from the plate cylinder 602 and inserting it into the receiving device, or by guiding a new printing plate for carrying out the print job out of the receiving device and mounting it on the plate cylinder 602. For example, at least one guide plate for guiding printing plates is provided. Preferably, a drive means is provided, which moves the printing plate out of the receiving device to the plate cylinder 602 or vice versa. Preferably, a used printing plate is detached from the outer surface of the plate cylinder 602 and is pulled off the plate cylinder 602 by rotation of the plate cylinder and transferred into the receiving device. After the utilized printing plate has been removed, a new printing plate is preferably released from the receiving device thereof and is mounted on the plate cylinder 602 by means of the drive means and/or by rotation of the plate cylinder 602 in the opposite direction. The new printing plate is subsequently attached to the plate cylinder 602, preferably by applying the retaining force.

It is advantageous when the execution, in particular the completion, of a printing plate change is monitored by sensors. It is advantageous to bring the plate cylinder 602 into a predefined position in terms of the lateral register, for example, to zero it with respect to the lateral register, before a replacement of a printing plate between the plate cylinder 602 and the printing plate magazine is carried out. As an alternative to setting the plate cylinder 602, it is also possible to bring the printing plate magazine laterally into a predefined position relative to the plate cylinder 602 so that the replacement of a printing plate between the printing plate magazine and the plate cylinder 602 can take place purposefully and without lateral offset. Likewise, the printing plate magazines, in conjunction with the plate cylinders 602, can be controlled in such a way that a printing plate change can be selectively prompted from a control console that is assigned to the processing machine 01 and/or by the machine control system. Since the printing plate magazines can be prepared for a printing plate change during ongoing production of the processing machine 01, the makeready time necessitating the application units 600 to be at idle is reduced to an extremely short time period of, for example, less than two minutes, preferably of less than ninety seconds, to completely change all printing plates of the application units 600 arranged in this processing machine 01. Such a rapid printing plate change, even with a larger number of printing plates, considerably increases the economic efficiency of the processing machine 01 due to the extremely short idle time thereof.

For example, the application unit 600 comprises at least one cleaning device, preferably washing device, for cleaning, in particular washing, at least one of the cylinders 602; 603; 608. Washing is advantageously carried out using water and/or a cleaning agent that is matched to the particular application fluid. In particular, at least one cleaning device can be set and/or is set against the plate cylinder 602. Preferably, at least one further cleaning device can be set and/or is set against the supply roller 603. As an alternative, the cleaning device of the plate cylinder 602 can likewise be used to clean the supply roller 603 and/or the impression cylinder 608, for example, by setting the cylinders 602; 603; 608 against one another during the cleaning process. The at least one cleaning device is preferably functionally connected to the at least one control unit of the machine control system.

In a preferred embodiment, the processing machine 01 comprises more application units 600 than are required for a normal application job. This means that the processing machine 01 comprises at least two application units 600, wherein one of the application units 600 can at least be used as a redundant application unit 600. In the case of multicolor printing, four application units 600 are typically employed. These four application units 600 are preferably printing units 600. In addition, it is also possible for further units 600 designed as varnish application units 600 to be present. More preferably, the processing machine 01 comprises four further application units 600 for multicolor printing. These four application units 600 can usually undergo maintenance and/or set-up steps while the other units 600 are running during operation. These four further application units 600 can at least be employed as redundant application units 600. As an alternative, these additional application units 600 can also be employed for special print jobs. For example, it is also possible to apply special colors and/or varnishes using the additional application units 600.

Furthermore, the processing machine 01, for example, comprises at least one unit designed as a drying device, in particular a drying unit, which more preferably is designed as a module, in particular as a drying module. As an alternative or in addition, at least one drying device 506 and/or at least one after-drying device, for example, is an integral part of at least one unit 100; 300; 600; 700; 900; 1000 preferably designed as a module 100; 300; 600; 700; 900; 1000. For example, at least one application unit 600 comprises at least one drying device 506 and/or comprises at least one unit 700 designed as a transport device 710 and/or at least one transport unit 700. The drying device 506 is preferably arranged downstream from the application point 609.

The processing machine 01 comprises at least one unit 700, in particular at least one transport unit 700, and/or the module 700, in particular the transport module 700. In addition, or as an alternative, the processing machine 01 preferably comprises transport devices 700, for example as integral parts of other units and/or modules. The at least one transport unit 700 is driven by a drive. This drive is, for example, mechanically coupled to further units 700, for example further transport units 700. As an alternative, the drive is mechanically decoupled from further units.

The processing machine 01 comprises the at least one shaping device 900, which is designed as a unit 900, in particular as a shaping unit 900 or die-cutting unit 900, and/or as a module 900, in particular as a shaping module 900 or die-cutting module 900 and/or as a die-cutting device 900. The processing machine 01 preferably comprises at least one shaping unit 900 designed as a die-cutting unit 900. The at least one shaping device 900 is designed as a rotary die-cutting device 900 and/or preferably comprises at least one shaping mechanism 914 or die-cutting mechanism 914. A shaping device 900 shall also be understood to mean an embossing device and/or a creasing device. A perforating device is preferably likewise a form of a die-cutting device 900. The shaping device 900 preferably comprises at least one plate cylinder 901 and at least one anvil cylinder 902. The plate cylinder 901 is designed as a cylinder 901, preferably as a die cylinder 901, and in particular a die-cutting cylinder 901. Preferably, the die-cutting cylinder 901 is or can be rotatably driven by a drive. The anvil cylinder 902 is designed as a cylinder 902. For example, the anvil cylinder 902 is also referred to as a counterpressure cylinder 902 of the shaping device 900. Preferably, the anvil cylinder 902 is or can be rotatably driven by a drive.

For example, a further cylinder 903, in particular die-cutting cylinder 903, is provided for changing the plate cylinders 901; 903, in particular die-cutting cylinders 901; 903. The at least one shaping device 900 preferably has at least one, and more preferably exactly one, processing point 909 designed as a shaping point 909. The at least one shaping device 900 preferably has the at least one, and more preferably exactly one, shaping point 909, which is formed by at least one, and more preferably exactly one, plate cylinder 901, in particular designed as a die cylinder 901, on the one hand, and at least one counterpressure cylinder 902 on the other. The shaping point 909 is preferably the region in which the particular plate cylinder 901 on the one hand and the particular counterpressure cylinder 902 on the other hand are closest to one another. The at least one shaping point 909 is preferably configured as at least one die-cutting point 909 and/or as at least one transport means 909 and/or as at least one shaping transport means 909 and/or as at least one die-cutting transport means 909. The shaping device 900, in particular the shaping mechanism 914, preferably comprises at least one tool; more preferably the at least one plate cylinder 901 comprises at least one tool. For example, the tools of the plate cylinder 901, preferably also referred to as die-cutting tools, comprise half shells 964 including die-cutting tools arranged thereon, such as cutting blades or embossing blades or creasing tools. Preferably, at least one cutting die, which is preferably designed as a half shell 964, is attached to the plate cylinder 901; 903. In a preferred embodiment, the tool of the shaping device 900, in particular of the shaping mechanism 914, preferably the tool of the plate cylinder 901, is in direct contact with the anvil cylinder 902, in particular in the region of the shaping point 909.

Preferably, the impression cylinder 608 and the anvil cylinder 902 must run at a synchronous speed during operation, preferably at the same surface speed. The tool is preferably adapted to the processing method, as a die-cutting tool, a creasing tool, an embossing tool and/or a perforating tool.

The plate cylinder 901 preferably comprises multiple tools for different processing methods at the same time. The at least one plate cylinder 901 designed as a die-cutting cylinder 901 comprises a tool having preferably vertically arranged blades. The blades are preferably discontinuously arranged and differ depending on the die-cutting job. For example, the blades differ in terms of the penetration depth. In particular, it is then not possible to specify a single surface speed for the die-cutting cylinder 901. The computation is then preferably carried out using a mean value. Preferably, the at least one starting diameter has to be entered into an interface to a control system prior to starting the machine, for example manually.

The at least one counterpressure cylinder 902 designed as an anvil cylinder 902 preferably comprises a cover or die-cutting blanket. The die-cutting blanket is preferably made of a plastic material and/or rubber and has slightly elastic properties. The die-cutting blanket is preferably made of a plastic material such as polyurethane or the like. The die-cutting blanket, for example, can be easily pushed in and at least partially return to its shape. Usually, such a die cutting blanket is between 10 mm and 12 mm thick, wherein between 4 and 8 mm can be removed by grinding. At least one grinding cylinder 911 or grinding roller 911 is arranged at or can be set against the anvil cylinder. The at least one grinding cylinder 911 comprises a drive, preferably a direct drive. The grinding cylinder 911 can preferably be set against the anvil cylinder 902 by means of servo drives.

The die-cutting unit 900 preferably comprises a vacuum system 966 for extracting waste parts or dust. The die-cutting unit 900 preferably comprises a housing. Preferably, the housing of the die-cutting unit 900 has at least one first wall and one second wall, which are arranged in the axial direction upstream and downstream from the transport path of sheets 02. Preferably, the housing is designed as a frame, for example for holding the cylinders 901; 902; 903 of the die-cutting unit 900.

The processing machine 01 preferably comprises at least one unit 1000 designed as a substrate output device 1000, in particular as a delivery device 1000, in particular a unit 1000 designed as a sheet delivery unit 1000, in particular a delivery unit 1000, which is more preferably designed as a module 1000, in particular as a delivery module 1000. The delivery unit 1000 is preferably the last unit 1000 of the processing machine 01. Preferably, at least one pile of the processed substrates 02 is formed in this unit. The delivery unit 1000 comprises at least one delivery pile carrier 1003 onto which processed substrates 02 can be deposited. A substrate 02 is decelerated along the transport path by at least one transport means preferably designed as a suction transport means. For example, the speed of the deceleration is adapted so that the substrate 02 is brought to a halt within one machine cycle. A rear region of the substrate 02, which is preferably situated closer to the trailing edge than to the leading edge of the substrate 02, is preferably detached from the decelerating transport means by means of at least one pusher, whereby underlapping by a succeeding substrate 02 is made possible. For example, the at least one pusher rotates or pivots about an axis that is oriented transversely to the transport direction T and, with each rotation or each pivoting, makes contact with a substrate 02 that, at this point in time, is present at the position of the transport path at which the pusher acts, and the rear region of which is then detached by the pusher. The rotational speed of the pusher is preferably adapted so that in each case the rear region of a substrate 02 is detached. At least one dropping means preferably detaches the decelerated substrate 02 completely from the decelerating transport means, preferably by downward pushing, whereby the substrate 02 is preferably deposited onto the delivery pile carrier 1003. Preferably, at least one stop for aligning the deposited substrate 02, preferably at least one stop for the leading edge and/or at least one stop for the trailing edge of the substrate 02, is provided in the region of the delivery pile carrier 1003. Lateral stops are also provided, for example.

Preferably, at least one diverted delivery 1002 is provided, in which sample sheets and/or substrates 02 of insufficient quality can be deposited and separated from the other substrates 02. The transport path of the substrate 02 can preferably be altered by way of at least one sheet diverter 1001 so that a substrate 02 is conducted into the diverted delivery 1002, instead of to the delivery pile carrier 1003.

The processing machine 01 comprises multiple sensors. These can be used, for example, to detect the arrival of the sheet at certain points of the processing machine 01. Furthermore, the sensors can also be designed as cameras and, for example, inspect the result of the processing operation. Such an inspection system is preferably designed as a printed image monitoring system 726 for inspecting a print image. Furthermore, such a sensor can be a color register monitoring system 728. The printed image monitoring system 726 and the color register monitoring system 728 are preferably arranged downstream from the application units 600 and preferably inspect the entire print image and/or printed register marks. Furthermore, the processing machine 01 preferably comprises a die-cut image monitoring system 916. This system is preferably arranged downstream from the die-cutting unit 900. A sheet 02 can be channeled out of the processing machine 01, for example, by means of the sensors 726, 728, 916. For this purpose, the processing machine 01 preferably comprises a sheet diverter 1001 and an ejection pile 1002, also referred to as a diverted delivery 1002. If deviations in the print and/or die-cut quality occur, the sheet diverter 1001 can be controlled by means of the signals of the sensors 726, 728, 916, and the sheets can be deflected in the transport path and thus be delivered onto the ejection pile 1002. If, in contrast, the print quality and/or die-cut quality are sufficient, the sheet 02 is preferably deposited on a delivery pile carrier 1003 of the sheet delivery unit 1000. Furthermore, the sheet processing machine 01 comprises multiple sheet arrival sensors 164; 622; 722; 922. Furthermore, changes in the printing length of the die-cutting length may occur over time. These changes can likewise be detected by the sensors, and the cylinders, in particular the plate cylinders 602; 901; 903, can subsequently be controlled by open loop and/or closed loop control by way of the signals.

The processing machine 01 comprises the at least one machine control system. The machine control system is preferably a higher-level control system of the processing machine 01, which comprises at least one control unit. The machine control system preferably comprises at least one central control unit to control processes of the processing machine 01. The central control unit is preferably coupled to means for controlling individual units 100; 300; 600; 700; 900; 1000 and/or to means for controlling individual components, such as, for example, a cylinder 602; 603; 608; 901; 902; 903 or a device for changing 950 plate cylinders 901 within a unit 100; 300; 600; 700; 900; 1000. The coupling is preferably achieved by means of electrical control lines and/or by means of wireless transmission technology, such as, for example, radio or WLAN or Bluetooth, preferably in the radio frequency range or alternatively in the infrared or optical frequency range. In particular, the machine control system is accessible and/or displayable to an operator via at least one display means, preferably by means of at least one monitor or display, and/or on at least one control console that, for example, comprises at least one display means. For example, in addition or as an alternative, the machine control system is accessible and/or displayable via at least one mobile terminal, for example a smart phone. The machine control system preferably comprises at least one processing unit, for example, at least one processor, preferably designed to calculate data and/or to calculate comparisons between data.

At least one sensor 164; 622; 722; 726; 728; 922; 916 of the sensors 164; 622; 722; 726; 728; 922; 916 preferably has at least a data connection to at least one control unit of the machine control system. The machine control system, in particular the at least one control unit thereof, preferably evaluates data of the at least one sensor 164; 622; 722; 726; 728; 922; 916. Preferably, a monitoring result of the at least one sensor 164; 622; 722; 726; 728; 922; 916 is displayed on at least one monitor. For example, the at least one sensor 164; 622; 722; 726; 728; 922; 916 is controlled by the machine control system and/or by an operator, by way of access to the machine control system, for example, via the at least one control console of the processing machine 01. Preferably, at least one component of the processing machine 01 is controlled, based on the data ascertained by the at least one sensor 164; 622; 722; 726; 728; 922; 916, by the machine control system and/or by an operator, by way of access to the machine control system, for example, via the at least one control console of the processing machine 01.

The tool of the at least one plate cylinder 901 of the shaping unit 900 determines the shaping result achieved by the processing of a substrate 02. This is also referred to as a die-cut pattern, for example. Since the tool of the at least one plate cylinder 901 of the at least one shaping unit 900 is adapted to a processing job to be carried out, there is a need to change the tool when changing to another processing job.

In a first specific embodiment, the tool is removed from the plate cylinder 901 for changing the tool of the at least one shaping unit 900 while the plate cylinder is in a die-cutting position or in a position that, for example, is situated several millimeters away from the die-cutting position and backed away from the anvil cylinder 902, preferably a change-out position. The change is carried out manually by an operator, for example. During the modification, the operator must then be ensured access to the plate cylinder 901.

In a second specific embodiment, the at least one plate cylinder 901 is replaced with a further plate cylinder 903 including another tool and/or a tool differently positioned along the outer cylindrical surface for changing the tool of the at least one shaping unit 900. For this purpose, the at least one shaping unit 900 preferably comprises a device for changing 950 the plate cylinders 901; 903, in particular the cylinders 901; 903 designed as die-cutting cylinders 901; 903. A die-cutting cylinder 901 which, during operation, is in a die-cutting position can be changed out for a further die-cutting cylinder 903. The change preferably takes place automatically. The device for changing 950 comprises the components of the die-cutting unit 900 which are involved in and/or required for changing the cylinders 901; 903. In particular, the device for changing 950 comprises the at least one die-cutting cylinder 901 and the at least one further die-cutting cylinder 903 for changing out the at least one die-cutting cylinder 901. When, above and below, die-cutting cylinders 901; 903 or the change thereof is described, this shall preferably be applied to the respective plate cylinders 901; 903 of the shaping unit 900.

Preferably, the device for changing 950 the plate cylinders 901; 903 comprises at least one, preferably multiple, and in particular at least two, guides 958; 959. A transport system in particular includes the guides 958; 959. The two guides 958; 959 of the device for changing 950 are preferably designed as linear guides 958; 959. Preferably, a guide 959 is designed as a preferably predominantly horizontal guide 959, more preferably comprising at least one horizontal transport element. Preferably, a guide 958 is designed as a preferably predominantly vertical guide 958, more preferably comprising at least one vertical transport element 956; 960. Predominantly, here, preferably shall be understood to mean a greater directional component in the respective horizontal or vertical direction. In another embodiment, the guides 958; 959 can also be curved. When, above and below, mention is made of a horizontal guide 959, this wording preferably also encompasses the predominantly horizontal guide 959, that is, a curved guide having a greater directional component in the horizontal direction. When, above and below, mention is made of a vertical guide 958, this wording preferably also encompasses the predominantly vertical guide 958, that is, a curved guide 958 having a greater directional component in the vertical direction. Preferably, the at least one transport element 956; 960 includes at least one receiving area, preferably at least one shell-shaped receptacle, for the at least one plate cylinder 901; 903. The device for changing 950 preferably comprises a transport system for moving the die-cutting cylinders 901; 903. This system preferably comprises transport elements 956; 960, which receive the die-cutting cylinders 901; 903, for example on the cylinder journal thereof, and transport them along the guide paths, that is, in particular along the at least predominantly horizontal guide 959 and/or along the at least predominantly vertical guide 958, and/or to the different positions. The transport system thus preferably comprises the at least one guide 958; 959. Preferably, at least one guide rail 957 is provided, which more preferably is designed as a linear guide, along which the at least one transport element 956; 960 is preferably moved. The transport system preferably comprises the at least one transport element for predominantly horizontally moving the die-cutting cylinders 901; 903, and preferably comprises the at least one transport element 956; 960 for predominantly vertically moving the die-cutting cylinders 901; 903. These transport elements 956; 960 are designed, for example, as slides comprising holding arms. More preferably, these comprise a half shell for holding the die-cutting cylinder 901; 903. The half shell is preferably designed as a contact surface with the die-cutting cylinder 901; 903. Preferably, a respective transport element 956; 960 is arranged on each side of the housing. For example, the predominantly vertical guide 958 either comprises two transport elements 956; 960, or two transport elements 956; 960 on a shared transport device 972. In a particularly simple design embodiment, the two transport elements 956; 960 of the predominantly vertical guide 958 are arranged together on a shared transport device 972, in particular a carrier 972 and/or slide 972. The two die-cutting cylinders 901; 903 can then be moved in a predominantly, more preferably completely, vertical direction V by a movement of the transport device 972.

The die-cutting cylinders 901; 903 can be arranged in several positions in the device for changing 950. In particular, the die-cutting cylinders 901; 903 are moved along the guides 958; 959. During die-cutting, the die-cutting cylinder 901; 903, in particular the particular die-cutting cylinder 901; 903 that is being employed, is arranged in the die-cutting position. The cylinder is arranged at the shaping point 909, preferably above the anvil cylinder 902. During operation of the processing machine 01, the cutting blades, in the die-cutting position, come in contact with the die cutting blanket of the anvil cylinder 902. This position of the anvil cylinder 902 is referred to as the working position of the anvil cylinder 902. In this way, the processing point 909 is preferably formed by the die-cutting cylinder 901; 903 arranged in the die-cutting position and the anvil cylinder 902 arranged in the working position. The die-cutting position is thus the same position for both die-cutting cylinders 901; 903. In particular, the processing point 909 is thus in an identical position for the at least one die-cutting cylinder 901 and for the further die-cutting cylinder 903. The sheet 02 is preferably processed at the processing point 909 of the die-cutting unit 900 during operation, in particular regardless of which die-cutting cylinder 901; 903 is arranged in the die-cutting position.

For example, the plate cylinder 901 is arranged so as to be fixed in the die-cutting position by means of a locking mechanism. The locking mechanism is preferably opened for changing the plate cylinder 901. For example, the plate cylinder 901 is transferred from the die-cutting position into a change-out position, in which it is ready to be removed, by opening of the locking mechanism. In contrast, the cylinder 903 to be installed is arranged so as to be fixed in the die-cutting position by closing the locking mechanism. For example, the further cylinder 903 is transferred from the change-out position into the die-cutting position by closing of the locking mechanism. The locking mechanism is thus preferably designed so as to fix the die-cutting cylinder 901; 903 that is to be arranged in the die-cutting position at the particular point in time. Preferably, a drive, for example hydraulic drive, for opening and/or closing the locking mechanism, that is, preferably for fixing the plate cylinder 901; 903 in the die-cutting position and/or releasing it from the die-cutting position, is controlled by means of the machine control system.

The change-out position is preferably located on a direct guide path between the die-cutting position and a maintenance position. The change-out position is preferably shifted by several millimeters in relation to the die-cutting position, preferably by no more than 1 cm, preferably by no more than 5 mm, more preferably by no more than 1 mm, more preferably by no more than 0.5 mm, more preferably by no more than 0.05 mm. The change-out position is more preferably arranged so as to be spaced apart from the die-cutting position, in particular in the vertical direction V, and more preferably beneath the die-cutting position. In a preferred embodiment, the die-cutting cylinder 901; 903 is arranged so as to be located further away from the shaping point 909 in the change-out position than in the die-cutting position, preferably displaced in the direction of the preferably previously backed-away anvil cylinder 902, and more preferably displaced downwardly. Preferably, the change-out position is arranged, in the vertical direction, above, or preferably beneath, the die-cutting position. This is in particular the case when the locking mechanism pushes the die-cutting cylinder 901 or the further die-cutting cylinder 903 into a position and is then released. Particularly preferably, the locking mechanism is arranged so as to fix, and in particular push, the die-cutting cylinder 901; 903 from the opposite side, in particular from beneath, against the frame and/or an element that is fixed to the frame and/or the housing. Particularly preferably, the locking mechanism is arranged so as to fix and/or push the die-cutting cylinder 901; 903 from beneath against a contact surface, preferably in the form of a half shell, in a wall of the housing, in particular the housing wall, or into the frame.

As an alternative, the change-out position is identical to the die-cutting position, however with the locking mechanism being open. The die-cutting cylinder 901 is preferably exclusively transferred from the die-cutting position thereof into the change-out position thereof by the locking mechanism being released.

In a preferred embodiment, in the die-cutting position, the die-cutting cylinder 901; 903 is functionally connected to a drive rotatably driving the same. The drive is preferably arranged coaxially with respect to the axis of rotation of the die-cutting cylinder 901; 903 arranged in the die-cutting position thereof. The drive is preferably arranged at the housing of the die-cutting unit 900, preferably by means of a carrier, so as to be fixed to the frame and/or fixed to the housing. Preferably, the plate cylinder 901; 903 arranged in the die-cutting position is coupled by the machine control system to the drive rotatably driving the plate cylinder, for example by an axial displacement of at least one component of the drive and/or an activation of a coupling.

In a preferred embodiment, the device for changing 950 comprises the coupling for coupling and/or for decoupling the die-cutting cylinders 901; 903 to and/or from the drive for driving one of the die-cutting cylinders 901; 903. Preferably, the coupling is opened when the die-cutting cylinders 901; 903 are being changed, and the die-cutting cylinder 901 is thus decoupled from the drive thereof. In particular, the coupling couples the die-cutting cylinder 901; 903 arranged in the die-cutting position to the drive or the motor thereof. In the coupled state, the coupling can preferably be moved in the axial direction with the die-cutting cylinder 901; 903. For example, the coupling is moved with the die-cutting cylinder 901; 903 in the axial direction A during the register adjustment.

Preferably, the anvil cylinder 902 has the working position thereof and a backed-away position having a larger distance in relation to the processing point 909 and/or having a larger distance in relation to the plate cylinder 901 arranged in the die-cutting position. For example, a servo drive is designed so as to move the anvil cylinder 902 from the working position thereof into the backed-away position, and vice versa. The machine control system preferably controls the servo drive.

Along the guide path between the die-cutting position and the maintenance position, the guide path, preferably at a move-out position, changes the direction thereof, for example, beginning at the die-cutting position from a substantially horizontal guide 959 to a substantially vertical guide 958. The move-out position is preferably spaced apart from the die-cutting position in or counter to the transport direction T. The change-out position is preferably arranged along the guide path between the die-cutting position and the move-out position. The die-cutting cylinder 901 can preferably be removed predominantly horizontally from the change-out position and transferred into the move-out position. Predominantly horizontal shall, in particular, be understood to mean a direction having a predominantly horizontal component. This wording also encompasses inclined guides. The die-cutting cylinder 901; 903 can preferably be transferred from the change-out position into the move-out position, and/or vice versa, on the guide 959 designed as a linear guide. For example, at least one transport element is provided for this purpose, which holds and moves the plate cylinder 901; 903 to be moved. Preferably, the at least one transport element includes at least one shell-shaped receptacle for the at least one plate cylinder 901; 903.

Furthermore, one of the plate cylinders 901; 903, in particular die-cutting cylinders 901; 903, can be arranged and/or is arranged in a maintenance position for set-up and/or maintenance. In this maintenance position, the die-cutting cylinder 901; 903 can undergo maintenance and, for example, be readied for a new processing job. For example, a tool can be exchanged for a new one. This exchange is preferably carried out manually by an operator. Preferably, at least one half shell 964 to be removed is removed with the tool from the plate cylinder 901; 903, and at least one further half shell 964 is attached with a new tool or differently positioned tool to the plate cylinder 901; 903. The maintenance position is preferably arranged in a vertical direction V beneath the die-cutting position and/or the change-out position. More preferably, the die-cutting cylinder 901; 903 is then located at a comfortable height for an operator. This has the advantage that the die-cutting cylinder 901; 903 can be readied for the next processing job in a position that is at a height that is easy to reach for an operator. In addition, interfering elements are removed from the die-cutting cylinder 901; 903, which can thus be accessed easily from the surrounding sides. The maintenance position is preferably arranged on the vertical guide 958.

A further position in which the plate cylinders 901; 903, in particular die-cutting cylinders 901; 903, can be arranged is the waiting position. Preferably, one of the die-cutting cylinders 901; 903 is arrangeable in the waiting position and/or can be arranged therein and/or is arranged therein and/or is being arranged therein for guiding the two die-cutting cylinders 901; 903 past one another. The waiting position is used to guide two cylinders 901; 903 past one another and is located at least outside a guide path of a die-cutting cylinder 901. The guide path is the direct transport path between the die-cutting position and the maintenance position. Preferably, one of the die-cutting cylinders 901; 903 is arranged in the waiting position, while the other of the die-cutting cylinders 901; 903 is guided past the same. The waiting position is preferably situated outside a direct guide path between the processing position and the maintenance position of the plate cylinder 901, preferably spaced apart therefrom above or in or counter to the transport direction T. In a preferred embodiment, the waiting position is arranged at a similar height as or above the change-out position and/or the die-cutting position. Furthermore, the waiting position and the maintenance position are preferably arranged on the vertical guide 958.

The die-cutting cylinder 901 is changed by means of the device for changing 950 using the method described hereafter. During operation of the processing machine 01, while a processing job is being completed, the die-cutting cylinder 901 and the anvil cylinder 902 are arranged in the die-cutting position or working position. As a result of changing the plate cylinder 901, which hereafter is also described based on the example of the die-cutting cylinder 901, this cylinder is displaced from the processing position, in particular the processing position designed as a die-cutting position, into the maintenance position, while the at least one further cylinder 903, which hereafter is also described based on the example of the die-cutting cylinder 903, is displaced from the maintenance position of the further cylinder 903 into the processing position.

In a preferably first step, the anvil cylinder 902 is preferably backed away from the die-cutting cylinder 901 and transferred from the working position thereof into the backed-away position thereof. For this purpose, the anvil cylinder 902 is preferably predominantly displaced in the vertical direction V, preferably downwardly. During the changing process, the anvil cylinder 902 preferably remains in this position, that is, preferably in the backed-way position, and does not have to be moved. The locking mechanism is preferably released for changing the plate cylinder 901 and/or is closed for fixing the further cylinder 903 in the processing position. By releasing the locking mechanism, the die-cutting cylinder 901 can preferably be displaced out of the die-cutting position. The die-cutting cylinder 901 is displaced from the die-cutting position into the change-out position. In a preferred specific embodiment, the die-cutting cylinder 901 is decoupled from the drive, which preferably rotatably drives the plate cylinder 901, by way of the coupling, preferably before the locking mechanism is released, preferably prior to being transferred from the die-cutting position into the change-out position. In the change-out position, the die-cutting cylinder 901 is preferably carried by the transport element of the preferably horizontal guide 959. The further die-cutting cylinder 903, which is to replace the current die-cutting cylinder 901, is located in the maintenance position. The further die-cutting cylinder 903 is preferably preset while the at least one die-cutting cylinder 901 is in the die-cutting position, processing the substrate 02, that is, while a processing job is being completed. In the maintenance position, the die-cutting cylinder 903 is preferably prepared, for example, for the next processing job in a simple manner. For this purpose, a half shell 964 comprising the shaping tools, in particular cutting blades, is preferably replaced. The further die-cutting cylinder 903, for example, has already been prepared while the processing machine 01 has been operated with the at least one die-cutting cylinder 901, that is, preferably before the die-cutting cylinder changing process started. The plate cylinder 901 and/or the further cylinder 903 are preferably placed in the receptacle of the transport element 956; 960 and moved thereby along the at least one guide 958; 959. The two die-cutting cylinders 901; 903 are preferably guided past one another in the guides 958; 959. So as to replace the plate cylinder 901 with the further cylinder 903, the plate cylinder 901 or the further cylinder 903 is preferably positioned in the maintenance position so as to guide the plate cylinder 901 and the further cylinder 903 past one another. For this purpose, one of the die-cutting cylinders 901; 903 is temporarily stored and/or temporarily held in the waiting position. Either the die-cutting cylinder 901 is guided from the die-cutting position into the waiting position, or the further die-cutting cylinder 903 is guided from the maintenance position into the waiting position. The other cylinder 901; 903, which is not arranged in the maintenance position, is then preferably guided past the cylinder 901; 903 arranged in the maintenance position, preferably along the direct guide path. Subsequent to the cylinders 901; 903 being guided past one another, the cylinder 901 to be removed is preferably transferred into the maintenance position, and the cylinder 903 to be installed is transferred to the die-cutting position. The further cylinder 903 is preferably fixed in the processing position by the locking mechanism. In particular, the rotatably driving drive is coupled to the further cylinder 903 after the further cylinder has been arranged in the processing position. Thereafter, the anvil cylinder 902 is preferably again set against the die-cutting cylinder 903 arranged in the die-cutting position, in particular when this cylinder was previously backed away.

In the processing machine 01, the substrate 02 has to be transported to the processing points 609; 909. For this purpose, the processing machine 01 preferably comprises multiple transport units 700. A transport unit 700 preferably comprises at least one transport device 710. In other words, the processing machine 01 thus preferably comprises at least one transport unit 700 that transports sheet-format substrate 02, comprising at least one transport device 710 that transports sheet-format substrate 02. In a preferred embodiment, the transport device 710 is designed as a suction transport means, in particular as a suction box, preferably a roller suction system. The guide path of the cylinder replacement overlaps, for example, with the transport path of substrate 02. For this purpose, for carrying out the cylinder replacement, for example, at least one component of a transport unit 700 must be displaced out of the position thereof for transporting substrate 02. The die-cutting unit 900 preferably comprises a displacement device for displacing the at least one transport device 710. Preferably, a transport device 710 is displaced which is arranged upstream from the processing point 909 in the transport direction T. For example, the displacement device is driven by means of a drive 933, which is preferably controlled by the machine control system. If, for example, the drive 933 additionally drives the vertical guide 958 of the device for changing, in a particularly preferred embodiment a contact surface 992 is provided between the transport device 710 and the at least one transport element 956; 960; 972 of the vertical guide 958 so that both the transport device 710 and the at least one transport element 956; 960; 972 are displaced together. As an alternative or in addition, the transport device 710 can be displaced manually, for example by an operator. Preferably, only the part or the transport device 710 that is in the way during the die-cutting cylinder changing process is displaced during a die-cutting cylinder change. Preferably, the transport device 710 is displaced, preferably displaced or pivoted in the vertical direction V, so as to clear the guide path of the plate cylinders 901; 903. In particular after the change of the plate cylinders 901; 903 has been completed, the at least one transport device 710 is preferably displaced into the working position thereof again, in which it is arranged during a processing job.

Furthermore, a transport means 904 arranged downstream from the shaping unit 900, preferably the die-cutting unit 900, in the transport direction T can also be displaced in such a way that an operator can reach the die-cutting cylinder 901; 903 and/or the anvil cylinder 902 without difficulty. In particular, this transport means 904 is displaced when a manual replacement of the shaping tool is carried out or when the at least one plate cylinder 901 is to be made accessible to an operator. For this purpose, the transport means 904 can preferably be pivoted. For example, this transport means 904 arranged downstream from the die-cutting unit 900 is designed as a separation transport means 904 of a separation device 905. In particular, offcut pieces, which were generated as a result of the processing operation by means of the die-cutting cylinders 901; 903, are separated from the sheet 02 by means of the separation transport means 904, in particular if these were not already previously separated from the sheet 02. For this purpose, the separation device 905 is designed as a jogging device 905, for example. For example, the transport means 904 arranged downstream from the die-cutting unit 900 comprises an upper part and a lower part, for example an upper and a lower conveyor belt. For example, the upper part of the transport means 904 is pivoted upwardly, while the lower part of the transport means 904 is pivoted downwardly.

The die-cutting cylinder changing process can preferably be carried out fully automatically. The die-cutting unit 900 is preferably functionally connected to a machine control system. The cylinder changing process can be stored in this system and can then run fully automatically. The die-cutting unit 900 comprising the device for changing 950 is advantageously arranged inline in a processing machine 01, which is preferably designed as a sheet processing machine 01, comprising application units 600. These units 600, for example, also comprise devices for changing the cylinders 602; 603; 608 of the application mechanisms 614 in a simplified manner. In this way, a fully automatic cutting die changer, which is integrated inline, can contribute to a considerably more efficient overall machine.

There is a need to minimize the duration of a modification process between consecutive processing jobs, advantageously to reduce idle times of the processing machine 01 and increase the production thereof.

Above and below, a modification preferably describes all the processes that take place and are necessary to ready the processing machine 01 for a new processing job. A modification of the processing machine 01 preferably describes an alteration of a configuration and/or a replacement of at least one component of the processing machine 01 so as to subsequently generate a multiplicity of identical products, which particularly preferably differ in at least one property from the products prior to the modification or, alternatively, are identical thereto. In particular, during a modification, the processing machine 01 is adapted to data regarding a substrate 02 to be processed. In addition or as an alternative, during a modification, the processing machine 01 is adapted to data regarding a product to be achieved. The data regarding the substrate 02 to be processed preferably encompass at least the format of the substrates 02 to be processed, such as the length, width or thickness thereof, and/or the material of the substrates 02 to be processed, for example, encompassing the implementation thereof as paper, cardboard, corrugated cardboard or paperboard, and/or the surface structure thereof in the form of existing primer or whether it is primed substrate 02. The data regarding the product to be achieved preferably encompass at least the print image to be generated and/or a shaping result to be generated, in particular a die-cut pattern to be generated, and/or the number of multiple-ups per substrate 02.

For carrying out a first processing job, the processing machine 01 is preferably configured with a first configuration. For carrying out a directly succeeding processing job, the processing machine 01 is preferably configured in a second configuration, that is, the configuration usually has to be altered, and thus preferably at least one parameter of the processing machine 01 has to be adapted. So as to switch from a first processing job to at least one succeeding processing job, preferably at least the following steps are carried out.

The first processing job is being completed by the processing machine 01. During the first processing job, at least one substrate 02 is processed by way of the at least one processing unit 900 designed as a shaping unit 900 and/or the at least one, preferably at least two, more preferably at least four, for example six, processing units 600 of the processing machine 01 designed as application units 600. The substrate 02 is preferably cut and/or die-cut and/or creased and/or perforated and/or embossed by the at least one shaping unit 900. The at least one shaping unit 900 is preferably designed as a rotary die-cutting device 900. Preferably, at least one application fluid is transferred onto the substrate 02, preferably at least one print image is applied to the substrate 02, by means of the at least one application unit 600 of the application units 600. For example, at least one colored print image is applied and/or the substrate 02 is coated and/or primed.

Prior to the modification, preferably while the first processing job is being completed, the configuration of the processing machine 01 for the at least one succeeding processing job, at least for the directly succeeding processing job, is loaded into and/or set in and/or stored in the machine control system. A data set that was stored at an earlier point in time is preferably accessed when loading the configuration and preferably encompasses the data of the configuration to be set or has only minor deviations between the stored data and the required data of the configuration to be set. This previously stored data set is then, for example, individually adapted according to the requirements of the processing job, for example, by altering individual data of the data set. Setting of the processing job shall preferably be understood to mean the adaptation of a loaded data set to the required configuration, for example, by adaptation of individual data. For example, the data are adapted by the machine control system or by the operator. Setting shall preferably additionally be understood to mean a compilation of the data of the data set directly from individual data, preferably when no previously stored data set is available or extensive alterations to an existing data set would be required. The adapted data set of the configuration is preferably stored in the machine control system and is thus available for later reuse. The duration of the modification process is advantageously shortened by loading and/or setting and/or storing the configuration. In a preferred embodiment, a previously stored configuration is loaded.

The machine control system preferably specifies the configuration of the processing machine 01 for the at least one succeeding processing job as well as the modification processes to be carried out in this regard. Preferably, the data regarding a substrate 02 to be processed and/or the data regarding a product to be achieved by the at least one succeeding processing job are stored and/or have been stored in the machine control system for this purpose. For example, the data regarding a substrate 02 to be processed and/or the data regarding a product to be achieved by the at least one succeeding processing job are entered by an operator or loaded from a previously stored template, preferably at the request of an operator. Preferably, only the data regarding a substrate 02 to be processed and/or the data regarding a product to be achieved must be entered and/or set by an operator for the succeeding processing job. Preferably, by processing these data, preferably taking further machine-related data provided by the machine control system into consideration, the machine control system specifies the configuration of the processing machine 01 preferably for the at least one succeeding processing job as well as the modification processes to be carried out in this regard. This advantageously minimizes the data volume to be entered by an operator, whereby input errors are advantageously minimized and/or the time required for manual configuration is reduced. The machine-related data preferably encompass a configuration of the units 100; 300; 600; 700; 900; 1000 of the processing machine 01 that applied prior to the modification process, that is, was set at the processing machine 01 for the first processing job, for example, regarding the existing unit arrangement and/or utilized tool of the at least one shaping unit 900 and/or utilized printing plates of the application units 600 and/or the assignment of application fluid to the application units 600 and/or utilized height of the substrate pile and/or settings of elements of the processing machine 01 regarding the format of the substrates 02 to be processed. In addition or as an alternative, the machine-related data encompass the state of individual elements, for example, regarding maintenance intervals to be observed and/or necessary cleaning processes and/or regarding the wear of the particular element. The machine-related data are preferably stored in the machine control system as a basis for the calculation; for example, these data are based on settings stored in the machine control system and/or internal calculations and/or sensor measurements in the processing machine 01. Preferably, the machine-related data are created by the machine control system, preferably without action by the operator, and provided for processing for the calculation.

The machine control system preferably calculates a necessary configuration of the processing machine 01 for producing this product from the data regarding a substrate 02 to be processed and/or the data regarding a product to be achieved. Preferably, the machine control system, for example, the at least one processing unit thereof, compares the configuration set at the processing machine 01 for the first processing job to the required configuration of the at least one succeeding processing job, in particular at least of the directly succeeding processing job. From the comparison, the machine control system preferably calculates the modification processes to be carried out for setting the new configuration. The machine control system moreover preferably adds modification processes based on a comparison between the states of individual elements and a reference value, for example, maintenance to be carried out and/or a necessary cleaning process. The machine control system thus preferably creates a data set encompassing the modification processes to be carried out as well as the properties of the processing machine 01 for carrying out the at least one succeeding processing job. This data set is preferably displayed to an operator on at least one display of the processing machine 01 and/or on a control console. Preferably, patterns regarding the flow of the individual modification processes as well as regarding a chronological order of mutually dependent modification processes are stored in the data set. Preferably, as many modification processes as possible, preferably in each case at least one modification process of a unit 100; 300; 600; 700; 900; 1000 to be modified, are carried out so as to temporally overlap, preferably parallel to one another.

The machine control system preferably suggests at least one data set encompassing the at least one configuration of the succeeding processing job as well as of the modification processes to be carried out, which can be adapted or selected by an operator. For example, the machine control system creates a suggestion for setting the configuration, which particularly preferably can be further adapted by an operator, for example by selecting or deselecting a modification process, such as, for example, a cleaning process or a tool replacement. For example, as an alternative, the machine control system creates at least two alternative suggestions from which an operator can select. Preferably, an operator must approve the specified or optionally adapted data set before the modification process begins, for example, by pressing a symbol on a display or a push button regarded as confirmation. The altered and/or adapted data set is preferably stored in the machine control system. It is thus preferably available for repeating the processing job later.

The machine control system automatically terminates the first processing job, that is, preferably without any explicit action by the operator at this point in time. Preferably, at least one counter is provided for this purpose, which counts the processed substrates 02 and/or the substrates 02 to be processed. The count is preferably transmitted to the machine control system by means of data transmission and more preferably is compared therein to a target value. When the required count of the processing job is reached, the processing job that is carried out is preferably terminated.

The first processing job is preferably terminated as soon as the substrates 02 provided in the pile of the piling region of the substrate feed device 100 have been processed or the number of products to be achieved from the first processing job has been reached or, after the number of products to be achieved has been reached, the remaining substrates 02 of the at least one feeder pile 104 have been processed. For example, the pile of the piling region has more substrates 02 than the number of products to be achieved from the processing job. Preferably, no further substrates from the pile of the piling region are delivered to the at least one feeder pile 104, at least starting from the point in time at which the number of products to be achieved was reached in the delivery unit 1000. Preferably, only the substrates 02 that are already situated on the conveyor path and/or present in the feeder pile 104 are delivered or processed further by the processing machine 01 starting from the point in time at which the product count to be achieved has been reached, preferably before a modification process is started. To end the processing job, the at least one feeder pile 104 is preferably operated until empty, preferably until the remaining substrates 02 thereof have been conveyed or processed by the processing machine 01 and deposited onto a delivery pile. For example, these remaining substrates 02 are deposited on the delivery pile carrier 1003 after the products have been processed or they are deposited on an alternative delivery pile, for example in the diverted delivery 1002. The substrate pile of the delivery pile carrier 1003, which preferably encompasses the substrates 02 processed for the first processing job, is preferably removed from the processing machine 01, that is, transported away. The produced products are, for example, further processed in a downstream process, for example, on another machine, preferably so as to produce end products.

Above and below, ‘automatically’ preferably describes an established flow of a process that is independently carried out by the processing machine 01, in particular controlled by the at least one machine control system. Above and below, an automated process preferably describes the opposite of a manual process, that is, a process carried out by an operator.

The modification of the processing machine 01 for adapting at least one unit 100; 300; 600; 700; 900; 1000 of the processing machine 01 to a configuration of a directly succeeding processing job is carried out after the first processing order, in particular after the same has been terminated. The modification starts automatically, that is, controlled by the machine control system, in particular without action by the operator. At least one modification process is carried out. Preferably, at least two modification processes run automatically. These at least two modification processes are preferably controlled by the machine control system, preferably without additional action by the operator for carrying out and/or starting the particular process. At least two modification processes run so as to temporally overlap with, preferably be parallel to, one another, which are controlled by the machine control system, and still more preferably run automatically. The set configuration for the directly succeeding processing job preferably forms the basis for the control of the modification processes by the machine control system.

During the modification, at least one modification process of the at least one shaping unit 900 takes place so as to temporally overlap with, more preferably so as to be parallel to, at least one further modification process of the processing machine 01. The machine control system controls the at least two modification processes running with temporal overlap, preferably automatically, that is, preferably without additional action by the operator for carrying out and/or starting the particular process. In a preferred embodiment, during the modification, at least three modification processes of the components of the processing machine 01, more preferably three modification processes of the processing units, still more preferably at least of the at least one shaping unit 900 and of the at least one application unit 600 and of the at least one substrate feed device 100 and of the at least one delivery unit 1000, run so as to temporally overlap with one another, and preferably run automatically. The units 100; 300; 600; 700; 900; 1000 that the processing machine 01 preferably comprises are at least the at least one shaping unit 900, the at least one application unit 600, the at least one substrate feed device 100, and the at least one delivery unit 1000, wherein more preferably at least three modification processes of these components of the processing machine 01 run automatically so as to temporally overlap with one another during the modification. At least two of the modification processes, preferably all of the performed modification processes, preferably run automatically according to the pattern for setting the required configuration stored in the machine control system.

The machine control system controls at least the at least two modification processes that run so as to temporally overlap. More preferably, at least the modification processes that run so as to temporally overlap run automatically during the modification, that is, preferably without action by the operator, whereby the operator can advantageously carry out further processes, such as modifying another element. A process that takes place without action by the operator preferably describes that the machine control system automatically triggers the start of the process and/or automatically carries out the process, for example, without explicit approval by the operator at the beginning of this process.

After the modification has concluded, the directly succeeding processing job is started.

The directly succeeding processing job is preferably started manually by the operator. The processing machine 01 is preferably unlocked during the preceding modification so that at least one unit 100; 300; 600; 700; 900; 1000 becomes accessible to the operator, and the operator can preferably carry out at least one manual modification process. To ensure the safety of the operator, it is thus necessary for the operator to confirm that he or she has left the active region of the processing machine 01. Preferably, the directly succeeding processing job does not start until confirmation has been provided, for example, by pressing a pushbutton or a control panel, by the operator.

During the directly succeeding processing job, at least one substrate 02 is processed by way of the at least one processing unit 900 designed as a shaping unit 900 and the at least one processing unit 600 of the processing machine 01 designed as an application unit 600, preferably is die-cut and/or creased and/or perforated and/or embossed or printed and/or coated and/or primed. A generated die-cut pattern and/or generated print image of the second processing job preferably differs from that of the first processing job. For example, a counter for counting the substrates 02 to be processed or that were processed starts to count at zero at the beginning of the new processing job.

For example, at least one further succeeding processing job follows. Preferably, a modification of the processing machine 01 is provided for between each processing job. A modification is preferably prepared and/or specified and/or loaded into the machine control system and/or set and/or stored at least prior to the particular modification, for example, prior to the modification for the processing job directly succeeding the first processing job, more preferably while the first processing job is being completed. This advantageously shortens necessary settings at a later point in time. The operator can thus start to prepare the processing jobs at the earliest possible time. As an alternative, the particular configuration is prepared and/or set at the least during the respective directly preceding processing job.

The machine control system preferably controls the termination of the first processing job and/or the start of the modification and/or the execution of at least the temporally overlapping modification processes of the modification and/or a termination of the modification. These processes preferably run automatically, that is, preferably without any further action by the operator. As an alternative, at least the necessary operations that an operator must perform for carrying out these processes are reduced. This preferably shortens the idle time. The operator can preferably already make preparations for further succeeding processing jobs and/or enhance the monitoring of the quality of the produced products and/or perform maintenance work on elements of the processing machine 01 which are not used in the presently running processing operation.

In a preferred refinement, the at least three consecutive processing jobs are fed to the machine control system. The machine control system preferably creates the configurations of the processing jobs and calculates the necessary modification processes between the processing jobs. The machine control system preferably proposes a sequence for completing the processing jobs to the operator, which preferably minimizes the duration and/or number of modification processes between the individual processing jobs.

Hereafter, examples of the modification processes of the individual units 100; 300; 600; 700; 900; 1000 will be described in more detail.

Preferably, an adaptation to a format of a substrate 02 to be processed is carried out, for example automatically, during at least one modification process of the at least one substrate feed device 100 of the processing machine 01. For this purpose, a position of at least one component of the substrate feed device 100 is preferably altered for the adaptation to the format of a substrate 02 to be processed. For example, a distance between the stream feeder and the storage area 166, for example the at least one front stop of the storage area 166, is adapted to the format. In particular, the distance is decreased for a smaller format for the succeeding processing job, while the distance is increased if the format is larger. For example, in addition or as an alternative, the distance between the stops aligning the substrate 02 at the piling region and/or the distance between the stops aligning the substrate 02 at the storage area 166 are adapted, in particular decreased when the succeeding processing job has a smaller format or increased when the format is larger. For example, in addition or as an alternative, the at least one blower device is moved closer to the piling region or is arranged further away therefrom. For example, in addition or as an alternative, the activation of the at least one acceleration means, preferably at least of the primary acceleration means, is adapted to the format. In particular, the point in time at which the acceleration starts and/or the duration of the acceleration and/or the length of the at least one acceleration means in the transport direction T are adapted. For example, the duration of the acceleration of the at least one acceleration means is set so as to end as soon as a further substrate 02 succeeding a substrate 02 to be accelerated makes contact with the at least one acceleration means. For example, the length of the at least one primary acceleration means is set so as to be shorter than the length of the substrate 02 to be processed.

The pile of substrate 02 of the piling region of the substrate feed device 100 is changed, for example, in the event of a format change or a change of the type of substrate 02, which can, for example, already take place while the feeder pile 104 is being operated until empty or during the modification. As an alternative, the pile of substrate 02 remains in the piling region when the format remains the same or the type remains the same.

Preferably, at least one modification process of the following modification processes is carried out on the at least one application unit 600, for example, on at least two of the application units 600: cleaning an application mechanism 614 and/or altering a distance between a plate cylinder 602 and an impression cylinder 608 of the at least one application unit 600 and/or changing an application fluid that is used and/or adapting an application volume of an application fluid that is used and/or changing a plate cylinder 602 of the at least one application unit 600 and/or changing at least one printing plate of the at least one application unit 600 and/or changing an anilox roller 603 of the at least one application unit 600. For example, only those application units 600 of the application units 600 for which the configuration is intended to be altered are modified. Preferably, at least one of the modification processes, preferably at least two of the modification processes, more preferably all of these modification processes run automatically.

In a preferred embodiment, at least one modification process of the at least one application unit 600 runs preferably so as to temporally overlap with, preferably parallel to, the at least one modification process of the at least one shaping unit 900. Preferably, at least this temporally overlapping modification process runs automatically. Advantageously, the different processing units 600; 900 are modified simultaneously, and a necessary idle time is reduced.

For example, the change of the plate cylinder 602 of the application unit 600 is carried out in the case of a format change of the substrate 02, in particular when the length of an area of the substrate 02 to be printed exceeds a circumferential length of the plate cylinder 602 provided for at least one printing plate of a previously used plate cylinder 602. For example, the change of the plate cylinder 602 of the application unit 600 is carried out manually or by a device that is identical to the device for changing 950 the at least one shaping unit 900.

The at least one printing plate of the plate cylinder 602 is preferably changed in particular to alter a print image to be generated. For example, the printing plate to be removed is pulled automatically off the plate cylinder 602 and subsequently a new printing plate is mounted automatically. The printing plate to be removed is preferably held by at least one holding means while the plate cylinder 602 carries out a rotation about the axis of rotation thereof, whereby the printing plate is scraped off the plate cylinder 602. The new printing plate is set against the plate cylinder 602 and placed against the outer cylindrical surface thereof by rotation of the plate cylinder 602. The previously used printing plate is preferably cleaned, preferably washed, prior to being replaced.

The utilized application fluid of at least one application unit 600 is preferably changed, for example, from a first ink to a second ink. When the ink assignment is changed, preferably additionally or alternatively the at least one application mechanism 614 of the application unit 600, preferably at least the at least one printing plate of the plate cylinder 602 and/or the at least one anilox roller 603 and/or the at least one impression cylinder 608 are cleaned, preferably washed. The cleaning preferably takes place before the application fluid is changed. For example in addition or as an alternative, the at least one anilox roller 603 of the application unit 600 is replaced with a further anilox roller 603 when the ink assignment is changed, for example, the anilox roller is changed prior to the application fluid being changed. For example in addition or as an alternative, the at least one printing plate of the plate cylinder 602 of the application unit 600 is replaced with a further printing plate when the ink assignment is changed. For example, the at least one printing plate is changed prior to the application fluid being changed.

For example in addition or as an alternative, the application volume of the application fluid of the at least one application unit 600 is altered. For this purpose, the at least one anilox roller 603 of the application unit 600 is preferably replaced with a further anilox roller 603. For example, the change of the anilox roller is carried out simultaneously with a change of the printing plate. As an alternative, the anilox roller 603 is changed before or after the at least one printing plate.

For example, for the adaptation to a different thickness of a substrate 02, a distance between the plate cylinder 602 and the impression cylinder 608 when arranged at the application point 609 is adapted during the modification. The plate cylinder 602 and the impression cylinder 608 are preferably arranged so as to not make contact when no substrate 02 is present, while they make contact when a substrate 02 is present and exert a sufficient pressing force on the substrate 02 for transferring the application fluid. The adaptation of the distance between the plate cylinder 602 and the impression cylinder 608 is preferably a last modification process of the application unit 600 before the modification ends.

For example, the modification process, designed as a cleaning process, of the application mechanism 614, preferably of the at least one printing plate, of the at least one plate cylinder 602 and/or of the at least one anilox roller 603 is also carried out for maintenance purposes, for example, after a predefined time interval and/or after a predefined number of processed substrates 02, preferably regardless of further modification processes of the application unit 600. A cleaning step is preferably carried out prior to at least one printing plate being changed and/or prior to an anilox roller 603 being changed and/or prior to a new application fluid being introduced.

For cleaning, the at least one plate cylinder 602, for example, also the plate cylinder 602 comprising the printing plate to be cleaned, is preferably rotated while at least one cleaning element is set against it and/or while at least one washing agent, for example water or a water-based cleaning agent, cleans the surface thereof. For example, the washing agent can also be transferred onto the plate cylinder 602 via the anilox roller 603. For example, the cleaning element is designed as a wiper or brush. The at least one cleaning element preferably wipes the outer cylindrical surface of the plate cylinder 602 or the at least one printing plate or the at least one anilox roller 603. In a preferred embodiment, the at least one cleaning process of the application mechanism 614 is started and/or carried out automatically. Preferably, the at least one cleaning element is set automatically against the at least one plate cylinder 602 or against the anilox roller 603 and/or is backed away automatically after the cleaning has been completed. The at least one plate cylinder 602 and/or the anilox roller 603 are preferably rotated automatically in the process. For example, the at least one chamber doctor blade 604 is, particularly preferably the doctor blade and the at least one intermediate reservoir are, automatically backed away from the anilox roller 603 and/or automatically set thereagainst after the cleaning has been completed.

An additional or alternative cleaning process is preferably a rinsing of the supply system of application fluid of the application unit 600 with a washing agent, preferably a water-based cleaning agent or water. Preferably, at least the at least one line 631, for example additionally the at least one intermediate reservoir of the at least one chamber doctor blade 604, is rinsed. For a preferred intensified cleaning process, the at least one washing agent is circulated in the supply system and, for example, additionally in the fluid source 629; for this case, the fluid source 629 is preferably arranged in the operative position. For example, at least a portion of the washing agent leaves the at least one line 631 through the at least one lance 632, whereby it is preferably conducted into a disposal unit, for example, a waste container.

The rinsing of the supply system and the cleaning of the plate cylinder 602 and/or of the anilox roller 603 are particularly preferably carried out together with at least one cleaning element in a combined cleaning process.

In particular, components of the application unit 600 are displaced. The displacement movements preferably take place during the modification of the application unit 600. Advantageously, a cleaning process is started and/or carried out automatically. Actions of an operator are advantageously reduced.

In a first step of a method for displacing the components of the application unit 600, in particular in a step of the particularly preferably rinsing cleaning process, application fluid that is present in the at least one line 631 is preferably removed from the at least one line 631, preferably recirculated into the at least one fluid source 629, or conducted into a disposal unit or conducted into the intermediate reservoir of the chamber doctor blade 604. Preferably in addition or as an alternative, the pump device pumping the application fluid through the at least one line 631 is stopped.

In a further step of the method for displacing the components of the application unit 600, in particular in a further step of the particularly preferably rinsing cleaning process, particularly preferably after the pump device was stopped, the at least one lance 632 of the at least one line 631 is preferably displaced from the first, lowered position in which it protrudes into a volume of the fluid source 629 arranged in the operative position into a second, raised position outside the volume of the fluid source 629. The at least two lances 632 are preferably displaced together via a shared holder and/or guide 633. The displacement preferably takes place along the at least one guide 633, preferably by lifting in the vertical direction V. The at least one lance 632 is preferably displaced by the at least one drive M4. Preferably, for displacing the at least one lance 632, the at least one drive M4 of the lance 632, which particularly preferably is designed as a pneumatic lift drive, is activated by the at least one control unit. Advantageously, the functional connection to the at least one fluid source 629 is interrupted as a result of the displacement of the at least one lance 632, whereby the fluid source 629 is advantageously released for a removal and/or displacement.

In a further step of the method for displacing the components of the application unit 600, in particular in a further step of the particularly preferably rinsing cleaning process, in particular after the at least one lance 632 was displaced into the second position, the at least one pushing-out device 623 is preferably activated by the at least one control unit. The at least one pushing-out device 623 preferably displaces the at least one fluid source 629, in particular the ink bucket, from the operative position in the movement direction B into the backed-away position, particularly preferably linearly oriented. Particularly preferably, for displacing the at least one fluid source 629, the at least one actuating means 626 of the at least one pushing-out device 623 displaces the at least one contact surface 624, which in particular establishes operative contact with the fluid source 629, of the at least one pushing-out device 623 from the first, deactivated position into the second, activated position. Advantageously, this eliminates pulling the at least one fluid source 629 out manually, offers relief to an operator, and expedites the modification process. When the at least one contact surface 624 is arranged in the first, deactivated position, the at least one pushing-out device 623 preferably enables the operative position for the arrangement of the fluid source 629, and when the at least one contact surface 624 is arranged in the second, activated position, it preferably blocks the operative position for the arrangement of the fluid source 629.

For example, the fluid source 629 arranged in the backed-away position is replaced by an operator with a further fluid source 629, in particular for changing the application fluid, and/or is filled with additional application fluid, in particular of the same kind as the existing application fluid.

In a further step of the method for displacing the components of the application unit 600, in particular in a further step of the particularly preferably rinsing cleaning process, particularly preferably as soon as or when the at least one fluid source 629 has left the operative position and/or was arranged in the backed-away position, preferably the at least one lance 632, in particular by activation of the drive M4, is displaced from the second position into the first, preferably lowered, position thereof or into a further position that is lowered compared to the second position, in particular by lowering counter to the vertical direction V. This advantageously clears previously blocked movement paths of further components of the application unit 600.

In a further step of the method for displacing the components of the application unit 600, in particular in a further step of the particularly preferably rinsing cleaning process, particularly preferably after the fluid source 629 has been displaced into the backed-away position, and with the lance 632 arranged in the second or in the lowered position, a cleaning process of the application unit 600 is preferably carried out. Particularly preferably, the supply system, in particular the at least one line 631, is rinsed with washing agent and/or the plate cylinder 602 is cleaned by the cleaning element set thereagainst and/or the anilox roller 603 is cleaned by the cleaning element set thereagainst. The rinsing and/or cleaning thus advantageously begins automatically, in particular without any necessary action by an operator.

Preferably after the cleaning process has been carried out, the fluid source 629 or a further fluid source 629 is preferably arranged in the operative position, for example by an operator or automatically by the at least one pushing-out device 623 or automatically by at least one further actuating device. The at least one lance 632 is preferably arranged in the second, lifted position and/or was displaced into the same. Moreover, after the cleaning process has taken place, the at least one lance 632 is preferably lowered into the volume of the fluid source 629 or of the further fluid source 629. The application fluid of the fluid source 629 can thus be conducted into the supply system again, in particular the at least one line 631, in particular by activation of the at least one pump device.

During the modification, for example, at least one setting of the at least one drying device 506 or of the at least one drying unit is adapted by the machine control system. Preferably, the intensity of the radiation, in particular of the UV or IR radiation or of the hot air stream, is altered, in particular increased or decreased, during the modification.

For example, an adaptation of the drying process is carried out when the application fluid of the application point 609 is changed, which is assigned to this drying device 506 or this drying unit, or when the application volume of the relevant application fluid is altered.

Preferably, a change of at least one anilox roller 603 takes place so as to temporally overlap with, preferably be parallel to, at least one modification process of the at least one shaping unit 900, in particular the change of the plate cylinder 901 or change of the tool. Preferably in addition or as an alternative to the change of the anilox roller, a change of at least one printing plate takes place so as to temporally overlap with, preferably be parallel to, at least one modification process of the at least one shaping unit 900, in particular the change of the plate cylinder 901 or change of the tool.

For example, identical modification processes are carried out parallel to one another on at least two application units 600.

During the modification, which preferably runs automatically, preferably the at least one plate cylinder 901 and/or the at least one anvil cylinder 902 of the at least one shaping unit 900 are removed from the processing point 909 of the at least one shaping unit 900, for example, backed away and/or removed and/or moved into a position located away from the processing point 909. Advantageously, the tool of the plate cylinder 901 can then be changed or the plate cylinder 901 can be replaced, without impairment by the anvil cylinder 902. The backing-away is thus carried out before a plate cylinder 901 is changed or before the tool is changed. In addition or as an alternative, the distance between the plate cylinder 901 and the anvil cylinder 902 is varied during the modification, which preferably runs automatically, preferably for the adaptation to a format of a substrate 02 to be processed, preferably increased when the substrate thickness is larger or decreased when the substrate thickness is smaller. The distance between the plate cylinder 901 and the anvil cylinder 902 is preferably adapted after a plate cylinder 901 has been changed or after the tool has been changed. More preferably, the adaptation of the distance between the plate cylinder 901 and the anvil cylinder 902 is a last modification process of the shaping unit 900 before the modification is terminated.

Advantageously, for changing the shaping result to be achieved, preferably also referred to as a die-cut pattern, the at least one plate cylinder 901 of the at least one shaping unit 900 is replaced with the at least one further cylinder 903 by the at least one device for changing 950 of the at least one shaping unit 900, preferably during the modification, which preferably runs automatically, in particular controlled by the machine control system. A particularly rapid replacement of the shaping result to be achieved is thus preferably achieved. The change process preferably takes place automatically, in particular controlled by the machine control system, that is, preferably without action by the operator. The processes preferably run automatically according to the pattern for setting the required configuration, stored in the machine control system. The tool of the plate cylinder 901 or of the further cylinder 903 is preferably changed on the plate cylinder 901 that is arranged in the maintenance position or the further cylinder 901. In the maintenance position, the cylinder 903 to be installed is preferably already preset while the first processing job is running and then is exchanged for the plate cylinder 901 to be replaced during the modification, without necessitating interventions by an operator. The processes required for replacing the plate cylinder 901 with the further cylinder 903 are preferably controlled by the machine control system, preferably carried out automatically.

For example, as an alternative to replacing the plate cylinder 901 with the further cylinder 903, the at least one tool of the at least one plate cylinder 901 is changed so as to change the shaping result to be achieved. In particular, the at least one tool is changed during the modification, for example manually by an operator. This is more cost-effective than changing the plate cylinder 901, for example, since only one plate cylinder 901 for receiving the tool must be held in reserve. For example, the particular tool, in a preferred embodiment the at least one half shell 964 comprising the tool, is manually removed from the plate cylinder 901 by the operator and attached to the plate cylinder 901. To do so, the at least one plate cylinder 901 is preferably made accessible to an operator automatically during the modification, that is, this preferably takes place without action by the operator. The machine control system thus preferably initiates the provision of this access as soon as the modification was started and/or as soon as the relevant shaping unit 900 was placed in idle during the modification. The provision of access is preferably achieved by backing the at least one plate cylinder 901 and the at least one anvil cylinder 902 away from one another. In the process, either both cylinders 901; 902 are moved, or only either the plate cylinder 901 or the anvil cylinder 902 is moved. In addition or as an alternative to backing the cylinders 901; 902 away, the provision of access is achieved by displacement of the at least one transport device 710 of a transport unit 700 of the processing machine 01, in particular the transport device 710 transporting sheet-format substrate 02, into a position located away from the working position thereof, for example, by lifting of the transport device 710 and/or by pivoting of the at least one transport means 904. Advantageously, the operator can then easily reach the plate cylinder 901 and change the tool thereof. For example, when only the manual replacement of the tool of the at least one plate cylinder 901 is carried out, the at least one device for changing 950 is then dispensed with, that is, is not integrated into the processing machine 01.

Changing the tool of the plate cylinder 901 of the shaping unit 900 shall preferably be understood to mean that other tools are employed for the new processing job, for example, blades having a new edge or tools of at least a different processing type, such as creasing, cutting, die cutting, embossing and/or perforating. Changing a tool shall preferably also be understood to mean that the same type of tool is provided before and after the change, but in a different arrangement, that is, a different tool placement.

An adaptation of the distance between the plate cylinder 901 and the anvil cylinder 902 at the shaping point 909 is another modification process of the at least one shaping unit 900. This is preferably carried out for format adaptation and/or after a tool or plate cylinder 901 has been changed. For example, regardless of whether merely the tool or the plate cylinder 901 is changed, the distance between the plate cylinder 901 and the anvil cylinder 902 is preferably adapted, preferably increased or decreased, when the thickness of the substrate 02 changes during a modification process of the shaping unit 900, to the thickness of the substrate 02 to be processed during the directly succeeding processing operation, to ensure optimal processing. The adaptation of the distance is preferably carried out automatically.

In a further or alternative modification process of the at least one shaping unit 900, the anvil cylinder 902 is preferably ground by way of the at least one grinding cylinder 911. For this purpose, the grinding cylinder 911 is preferably set against the outer cylindrical surface of the anvil cylinder 902, preferably in contact therewith, and the anvil 902 is made to rotate. For example as an alternative, the anvil cylinder 902 is ground while a processing job is being completed, preferably at regular intervals.

In an exemplary embodiment, the processing machine 01 comprises at least two shaping units 900, which are arranged one behind the other in the transport direction T. The tools of these shaping units 900 preferably differ from one another or the tool placements with respect to one another differ, for example so as to generate a different die-cut pattern. Examples of tools are die-cutting tool, embossing tool, creasing tool, perforating tool, and stripping tool. For example, a dedicated shaping unit 900 is provided for at least two of these tool types, preferably for each. At least one of these shaping units 900 is, for example also all are, then preferably adapted during the modification, for example, the plate cylinders 901 are changed or the tool is changed or the distance between the particular plate cylinder 901 and the anvil cylinder 902 thereof is adapted. In this exemplary embodiment of the processing machine 01, in a preferred embodiment at least one application unit 600 is arranged upstream from the shaping units or, alternatively, the processing machine 01 is designed without application units 600.

Preferably, an adaptation to a format of a substrate 02 to be processed is carried out during at least one modification process of the at least one delivery unit 1000 of the processing machine 01. The adaptation to the format is preferably carried out automatically. For changing the format, preferably at least one stop of the delivery unit 1000, preferably the at least one stop for the trailing edge and/or the at least one stop for the leading edge and/or the at least one lateral stop are displaced. The at least one stop is preferably moved from the existing position thereof further into the region of a substrate 02 to be deposited, or out of the same, depending on the format of the substrate 02 of the directly succeeding processing job. For example in addition or as an alternative to changing the position of the at least one stop, the rotational speed of the at least one pusher of the delivery unit 1000 is adapted to the format of the substrate 02. The rotational speed is preferably accelerated or decelerated so as to arrange the pusher in the active region thereof in the transport path of substrate 02 when the rear region of the substrate 02 is arranged there. This advantageously prevents the substrate 02, which is being detached, from being moved in or counter to the transport direction T as a result of the rotational movement of the pusher. For example in addition or as an alternative, the deceleration speed is preferably adapted by the at least one decelerating transport means. Smaller formats of the substrate 02 can, for example, be decelerated more slowly than larger formats since, at the same machine speed and/or cycle time, more time is available until the succeeding substrate 02 arrives. This preferably protects the substrate 02 and/or the decelerating transport means from wear.

For example, during a modification, in addition or as an alternative to further modification processes, the number of units 600; 900 processing the substrate 02 is altered. This advantageously avoids redundant processing units 600; 900, or an outcoupled processing unit 600; 900 can, for example, already be readied manually for a succeeding processing job during production. In a preferred embodiment, for reducing the number of application units 600, at least one application unit 600 is adapted so as to ensure the transport of substrate 02 along the transport path, however without processing the substrate 02. This is preferably achieved by an interruption in the supply of the application fluid to the plate cylinder 602, more preferably by backing the anilox roller 603 away from the plate cylinder 602. To increase the number, this at least one application unit 600 is then adapted to process substrate 02, that is, the supply of the application unit is preferably ensured, for example, by setting the anilox roller 603 against the plate cylinder 602. Advantageously, the number of utilized processing units 600; 900 can thus be quickly and easily adapted, without varying the total number and order of the processing units 600; 900. For example, in an alternative embodiment, at least one application unit 600 is removed from the transport path to reduce the number or is integrated therein to increase the number. For this purpose, the application units 600, for example, comprise servo drives for setting the application units 600 against and backing the application units away [from the cylinders]. Then, the positioning of the remaining units 100; 300; 600; 700; 900; 1000 of the processing machine 01 is preferably varied so that a continuous transport path of substrate 02 exists, that is, for example, by coupling the remaining units 100; 300; 600; 700; 900; 1000 to one another or by decoupling the existing units 100; 300; 600; 700; 900; 1000 and coupling the processing unit 600; 900 to be inserted. In particular when the number of application units 600 of the first processing operation which process a substrate 02 is different from the number of application units 600 of the at least one succeeding processing operation which process a substrate 02, preferably at least one application unit 600 for carrying out a processing operation of substrate 02 is adapted by setting the anilox roller 603 against the plate cylinder 602, or for transporting substrate 02 without simultaneously processing the substrate 02, is adapted by backing the anilox roller 603 away from the plate cylinder 602 in accordance with the count of the directly succeeding processing job, or at least one application unit 600 is preferably integrated into the transport path of substrate 02 or removed therefrom in accordance with the count of the directly succeeding processing job. Before the number of processing units 600; 900 is altered, the at least one application unit 600, to which the supply of application fluid is to be interrupted or which is to be removed, is preferably cleaned. For example, the removed application unit 600 is serviced or modified while in the removed state.

For example, a distinction can be made between at least two types of modification. The machine control system preferably selects the type of modification for an impending modification process or suggests the same to the operator for approval. Preferably regardless of the type of modification, the job data are changed in the machine control system, for example, in the control units thereof, when the processing job is changed. This relates, for example, to the creation of documentation, such as, for example, starting a new documentation document, saving the job data, and/or resetting at least one counter for counting the substrates 02 processed or to be processed for the particular processing job. Preferably, at least one unit, which is arranged downstream from the processing machine 01 in the process chain for processing substrate 02, for example, at least one palletizer and/or a folding machine and/or a gluing machine, is informed about the change of the processing job via data transmission, for example, via cable or wirelessly, preferably automatically by the at least one machine control system. This allows these units also to carry out the change at the right time.

In a first type of modification, preferably a significant deviation exists between a first product to be produced for the first processing job and a second product to be produced for the directly succeeding processing job. For example, the die-cut patterns and/or print images differ from one another or a change of substrate 02 exists. Preferably, when the substrate 02 to be processed changes, that is, the format or type of the substrate 02 changes, the at least one feeder pile 104 is preferably operated until empty during a modification of the first type in order to terminate the first processing job, for example, these substrates 02 likewise being processed on their way to the delivery unit 1000. These substrates 02 are preferably deposited on the delivery pile carrier 1003 and are further processed with the further products.

The processing machine 01 is preferably halted during the modification of the first type of modification. Preferably, a transport of substrate 02 through the units 100; 300; 600; 700; 900; 1000 of the processing machine 01 is halted. The components of the processing machine 01 designed for transporting a substrate 02 are preferably placed in idle during the modification. Preferably, at least the plate cylinders 602; 901 and/or impression or counterpressure cylinders 608; 902 and/or means driving substrate 02 of the at least one transport unit 700 shall be regarded as these components. Preferably, at least one transport device 710 of a transport unit 700 transporting, preferably sheet-format, substrate 02, preferably at least two transport units 700, preferably all transport units 700, of the processing machine 01 for transporting substrate 02 are halted during the modification. For example, the transport of substrate 02 through the processing machine 01 is interrupted for at least two minutes, for example at least three minutes. The duration of the interruption is, in particular, dependent on the modification processes to be carried out.

During the modification according to the first type of modification, preferably at least one unit 100; 300; 600; 700; 900; 1000 of the processing machine 01 is unlocked, for example, by releasing a lock of at least one safety cover. Preferably, at least this unit 100; 300; 600; 700; 900; 1000 is thus accessible to an operator during the modification. In the case of the first type of modification, the directly succeeding processing job is preferably started manually by an operator. This ensures that all modification processes were terminated successfully, and no operator is located in the active region of the processing machine 01, whereby the safety is preferably increased.

During the modification according to the first type of modification, preferably at least two, preferably multiple, modification processes are carried out so as to adapt the configuration to the succeeding processing job. Preferably, the at least two modification processes controlled by the machine control system, in particular the at least two temporally overlapping modification processes, are carried out. Preferably, a die-cut pattern to be generated of the at least one shaping unit 900 of the consecutive processing jobs is altered. In addition or as an alternative, preferably at least one print image, generated by at least one application unit 600 of the application units 600, is altered, and more preferably at least one further modification process is carried out on at least one further application unit 600 of the application units 600. For this purpose, the processing machine 01 preferably comprises the at least two, for example at least four, application units 600, and more preferably the at least one shaping unit 900. For example, the contour of a multiple-up is changed by altering the die-cut pattern and/or another processing operation, such as die cutting, embossing, creasing, perforating, is used for the succeeding processing job compared to the preceding processing job. For example, in addition or as an alternative, at least two print images, applied by at least two application units 600, are altered, preferably by altering the particular printing plate and/or the utilized inks. In the first type of modification, preferably at least two modification processes run on differing units 100; 300; 600; 700; 900; 1000 of the processing machine 01, in particular on at least two processing units 600; 900 so as to temporally overlap with, preferably parallel to, one another. For example in addition or as an alternative, at least one maintenance process and/or at least one cleaning process are carried out in the first type of modification.

In a second type of modification, preferably only a minor deviation exists between a first product to be produced for the first processing job and a second product to be produced for the directly succeeding processing job. The substrate 02 to be processed preferably remains unchanged compared to the first processing job, that is, has the same format and the same type, for example grammage. Preferably, the two products have an identical die-cut pattern. For example, the two products only differ in the print image, applied by an application unit 600, for example altered text and/or at least one added or missing symbol of an ink, while the print images of the further application units 600 are identical. For this purpose, the processing machine 01 preferably comprises the at least two, for example at least four, application units 600, preferably each comprising a plate cylinder 602, more preferably each designed as a flexographic application unit 600, and more preferably comprising the at least one shaping unit 900.

In the second type of modification, the components of the processing machine 01 designed for transporting a, preferably sheet-format, substrate 02 preferably continue to be driven during the modification, for example, rotated in the circumferential direction.

Preferably, at least the plate cylinders 602; 901 and/or impression or counterpressure cylinders 608; 902 and/or means driving substrate 02 of the at least one transport unit 700 shall be regarded as these components. For example, they are rotated at the speed with which a substrate 02, if the same is present, is processed during a processing job. For example, as an alternative, the speed of the components is reduced compared to the regular processing speed, the speed preferably being greater than zero. In particular, during the modification, at least one transport device 710 of a transport unit 700 transporting, preferably sheet-format, substrate 02, preferably at least two transport units 700, preferably all transport units 700, of the processing machine 01 for transporting substrate 02 are driven at at least one speed profile, the speed being greater than zero. The speed profile preferably corresponds to a driving speed during the completion of a processing job. The speed profile preferably encompasses a constant speed as well as a deceleration and/or an acceleration corresponding to the substrate guidance, the speed preferably being permanently different from zero. Preferably so as to ensure the safety of an operator given that the components for transporting substrate 02 are continuously driven, the units 100; 300; 600; 700; 900; 1000 of the processing machine 01 are preferably locked during the modification according to the second type, for example an activated lock of the safety cover being present. The units 100; 300; 600; 700; 900; 1000 are thus preferably not accessible to the operator during the modification.

In the second type of modification, a feeding of, preferably sheet-format, substrate 02 to the processing units 600; 900 is preferably blocked, for example in that the at least one acceleration means of the substrate feed unit 100, which in the activated state preferably pulls a single substrate 02 from a storage area 166 of a substrate feed unit 100 and accelerates the single substrate 02 to a processing speed of the processing units 600; 900, is deactivated. The individual substrate 02 is in particular a bottommost substrate 02 of the feeder pile 104. Preferably, while the components of the processing machine 01 designed to transport a substrate 02 continue to be driven, the feeding of substrate 02 is preferably blocked for only 0 to N substrates 02, with N preferably being a natural number smaller than or equal to 25, preferably smaller than or equal to 10, more preferably smaller than or equal to 5, more preferably smaller than or equal to three, more preferably smaller than or equal to two. The natural number N, in other words, describes a number between 1 and preferably 25, with the aid of which objects can be counted. The feeding of substrate 02 is preferably blocked for at least 1 to no more than 25, particularly preferably at least two and/or to no more than 15, still more preferably to no more than 5, still more preferably no more than 3, still more preferably no more than 2 substrates 02. In a particularly preferred embodiment, the substrate feeding is blocked for one to three substrates 02, preferably two to three substrates 02. As a result, preferably no or only a small gap is created in the substrate stream. In other words, when blocking is present, a gap is created in the substrate stream, which is preferably smaller than or equal to 25 substrates, particularly preferably smaller than or equal to 5 substrates. Preferably, the delivery of substrates 02 from the pile of the upstream piling region to the pile of the storage area 166 is preferably maintained unchanged during a modification of the second type.

During the modification of the second type, the first processing job is preferably terminated as soon as the number of products to be achieved from the first processing job has been reached. In particular, since the substrate 02 to be processed is unchanged for both processing jobs, that is, in particular for the first and second processing jobs, an operation of the at least one feeder pile 104 until there are no more substrates 02 is eliminated in the case of a modification of the second type.

During the modification according to the second type of modification, the at least one plate cylinder 901 of the at least one shaping unit 900 is preferably rotatably driven at a speed greater than zero, preferably the processing speed. Preferably, a die-cut pattern to be generated of the at least one shaping unit 900 of the consecutive processing jobs then preferably remains unchanged during the modification according to the second type of modification. Preferably, no modification process is carried out on the at least one shaping unit 900. The plate cylinder 901 of the at least one shaping unit 900 thus preferably remains in the die-cutting position thereof during the modification of the second type. As an alternative, at least one modification process is carried out on the at least one shaping unit 900.

In addition or as an alternative, preferably at least one print image, generated by at least one application unit 600 of the application units 600, of the consecutive processing jobs remains unchanged. Preferably, no maintenance process and/or cleaning process of the at least one application unit 600 is carried out.

Preferably in addition or as an alternative, preferably the configuration of at least one application unit 600 is altered during the modification of the second type of modification. In this way, preferably at least one modification process is carried out on at least one application unit 600 of the application units 600. Preferably, at least one printing plate of the at least one application unit 600 is changed. Preferably in addition or as an alternative, the number of application units 600 is increased by setting the at least one anilox roller 603 against the plate cylinder 602 of at least one application unit 600, and thus preferably the transfer of application fluid. For example as an alternative, the number of application units 600 is reduced by backing away at least one anilox roller 603. In a particularly preferred embodiment of the modification of the second type, a state thus occurs in the preferably at least two application units 600 in which at least one print image, generated by at least one application unit 600 of the application units 600, of the consecutive processing jobs remains unchanged, and the configuration of at least one further application unit 600, particularly preferably only one application unit 600 of all application units 600, is altered.

For example, preferably in addition to altering the at least one application unit 600, a pile change of substrate 02 is carried out during the modification of the second type of modification, preferably in the at least one substrate feed unit 100 and/or in the at least one delivery unit 1000.

The directly succeeding processing job preferably starts during the modification of the second type of modification by the blockage of the substrate feed being cleared, in particular by the at least one deactivated acceleration means being activated. Since the processing machine 01 is already being operated at the processing speed, rapid continued operation of the processing machine 01 is ensured. In the settings of the machine control system, the operator can preferably select whether the processing machine 01, with the succeeding processing job, is to directly continue production after the job has been started, or whether the machine, after having produced at least one sample sheet, is to interrupt the infeed again so as to allow the operator to inspect the quality of the at least one sample sheet. Advantageously, the interruption due to the modification in the second type of modification is shorter than in the case of a modification of the first type. This advantageously minimizes the idle time of the processing machine 01.

Although the disclosure herein has been described in language specific to examples of structural features and/or methodological acts, it is to be understood that the subject matter defined in the appended claims is not necessarily limited to the specific features or acts described in the examples. Rather, the specific features and acts are disclosed merely as example forms of implementing the claims.

1-29. (canceled)

30. A method for changing a processing job carried out on a processing machine (01), the processing machine (01) comprising a plurality of processing units (100; 300; 600; 700; 900; 1000), including at least one processing unit (600) configured as an application unit (600) including a plate cylinder (602), and at least one processing unit (900) configured as at least one shaping unit (900), the at least one shaping unit (900) being configured as at least one rotary die-cutting device (900), the method comprising:
completing a first processing job by the processing machine (01), during which at least one substrate (02) is processed by the at least two processing units (600; 900) of the processing machine (01);
automatically terminating the first processing job and automatically starting a modification;
completing the modification of the processing machine (01) for adapting at least one unit (100; 300; 600; 700; 900; 1000) of the processing machine (01) to a configuration of a directly succeeding processing job, prior to the modification the configuration of the processing machine (01) for the at least one succeeding processing job being loaded into and/or set and/or stored in a machine control system, and, during the modification, at least one modification process of the at least one shaping unit (900) running so as to temporally overlap with at least one further modification process of the processing machine (01); and the machine control system controlling the at least two modification processes that run so as to temporally overlap; and
starting the directly succeeding processing job, during which at least one substrate (02) is processed by the at least two processing units (600; 900).

31. The method according to claim 30, characterized in that, during the modification, at least one plate cylinder (901) and/or at least one anvil cylinder (902) of the at least one shaping unit (900) is automatically removed from a processing point (909) of the at least one shaping unit (900) and/or that, during the modification, the distance between a plate cylinder (901) and an anvil cylinder (902) of the at least one shaping unit (900) is automatically altered.

32. The method according to claim 30, characterized in that, during the modification, at least one plate cylinder (901) of the at least one shaping unit (900) is automatically replaced with at least one further cylinder (903) by at least one device for changing (950) the at least one shaping unit (900).

33. The method according to claim 32, characterized in that the plate cylinder (901), for the change process, is displaced from a processing position into a maintenance position, while the at least one further cylinder (903) is displaced from a maintenance position of the further cylinder (903) into the processing position and/or that, for changing the plate cylinder (901), the plate cylinder (901) or the further cylinder (903) is positioned in a maintenance position so as to guide the plate cylinder (901) and the further cylinder (903) past one another.

34. The method according to claim 30, characterized in that at least one tool of at least one plate cylinder (901) of the at least one shaping unit (900) is changed during the modification.

35. The method according to claim 30, characterized in that an adaptation to a format of a substrate (02) to be processed is carried out during at least one modification process of at least one substrate feed device (100) of the processing machine (01) and/or that an adaptation to a format of a substrate (02) to be processed is carried out during at least one modification process of at least one unit (1000) of the processing machine (01) which is designed as a delivery unit (1000) and/or that at least one feeder pile (104) is operated until empty in order to terminate the first processing job.

36. The method according to claim 30, characterized in that a change of at least one anilox roller (603) of the at least one application unit (600) and/or a change of at least one printing plate of the at least one application unit (600) take place so as to temporally overlap with at least one modification process of the at least one shaping unit (900).

37. The method according to claim 30, characterized in that the at least one application unit (600) is designed as a flexographic application unit (600) and/or that the processing units (600; 900) are designed so as to process sheet-format substrate (02) and/or that the processing machine (01) is designed as a sheet processing machine (01) and/or that a section of a transport path provided for a transport of substrate (02), which is defined by the particular unit (100; 300; 600; 700; 900; 1000), has a minimal radius of curvature that is at least 2 meters.

38. The method according to claim 30, characterized in that at least one modification process of the following modification processes is carried out on the at least one application unit (600): cleaning an application mechanism (614) and/or altering a distance between a plate cylinder (602) and an impression cylinder (608) of the at least one application unit (600) and/or changing an application fluid that is used and/or adapting an application volume of an application fluid that is used and/or changing a plate cylinder (602) of the at least one application unit (600) and/or changing at least one printing plate of the at least one application unit (600) and/or changing an anilox roller (603) of the at least one application unit (600).

39. The method according to claim 30, characterized in that the number of application units (600) of the first processing operation which process a substrate (02) is different from the number of application units (600) of the at least one succeeding processing operation which process a substrate (02).

40. The method according to claim 39, characterized in that at least one application unit (600) for carrying out a processing operation of substrate (02) is adapted by setting an anilox roller (603) against a plate cylinder (602), or for transporting substrate (02) without simultaneously processing the substrate (02), is adapted by backing the anilox roller (603) away from the plate cylinder (602) in accordance with the count of the directly succeeding processing job, or that at least one application unit (600) is integrated into the transport path of substrate (02) or removed therefrom in accordance with the count of the directly succeeding processing job.

41. The method according to claim 30, characterized in that at least one modification process of the at least one application unit (600) runs automatically and/or that at least the modification processes that run so as to temporally overlap with one another run automatically during the modification and/or that at least one modification process of the at least one application unit (600) runs automatically so as to temporally overlap with the at least one modification process of the at least one shaping unit (900).

42. The method according to claim 30, characterized in that data regarding a substrate (02) to be processed and/or data regarding a product to be achieved from the at least one succeeding processing job are stored or have been stored in the machine control system, and, by processing these data taking further machine-related data provided by the machine control system into consideration, the machine control system specifies the configuration of the processing machine (01) for the at least one succeeding processing job as well as the modification processes to be carried out in this regard, and/or that the machine control system proposes at least one data set encompassing at least one configuration of the succeeding processing job as well as the modification processes to be carried out in this regard, which can be adapted or selected by an operator.

43. The method according to claim 30, characterized in that at least one setting of at least one drying device (506) or of at least one drying unit is adapted by the machine control system during the modification and/or that at least one transport device (710) of a transport unit (700) of the processing machine (01) for transporting substrate (02) is halted during the modification and/or that at least one unit (100; 300; 600; 700; 900; 1000) of the processing machine (01) is unlocked during the modification.

44. The method according to claim 30, characterized in that the die-cut patterns and/or print images of the processing jobs differ from one another or a change of substrate (02) exists, and/or that the processing machine (01) comprises at least two processing units (600) that are designed as application units (600) comprising a plate cylinder (602) and at least two print images, applied by the at least two application units (600), are altered.
